(19) United States
(12) Patent Application Publication
(10) Pub. No.: US 2025/0319751 A1
(43) Pub. Date: Oct. 16, 2025

(54) Flush Glass System

(71) Applicants: Henniges Automotive Sealing Systems North America, Inc., Wilmington, DE (US); Henniges China Sealing Systems Co, Ltd, Beijing (CN); Henniges Automotive Sealing System Tieling Co, Ltd, Tieling (CN); Henniges Taicang Sealing System Co, Ltd, Taicang City (CN); Shanghai Hongyang Sealing Products Co, Ltd, Shanghai (CN)

(72) Inventors: Robert L. Merriman, Rochester Hills, MI (US); Henry G. Zilka, Oxford, MI (US); Weiming Zeng, Langfang (CN); Xiaohua Yu, Beijing (CN); Zhongyuan Wang, Beijing (CN)

(73) Assignees: Henniges Automotive Sealing Systems North America, Inc., Wilmington, DE (US); Henniges China Sealing Systems Co, Ltd, Beijing (CN)

(21) Appl. No.: 18/865,569

(22) PCT Filed: May 18, 2023
(86) PCT No.: PCT/US2023/022729

§ 371 Date: Nov. 13, 2024

Related U.S. Application Data
(60) Provisional application No. 63/351,570, filed on Jun. 13, 2022.

(30) Foreign Application Priority Data
May 18, 2022 (CN) 202221229280.X
May 18, 2022 (CN) 202221229420.3
May 18, 2022 (CN) 202221250924.3

(51) Int. Cl. B60J 1/17; B60J 5/04; B60J 10/79

(52) U.S. Cl. CPC B60J 1/17; B60J 5/0402; B60J 10/79

(57) ABSTRACT

A flush glass system for a vehicle door is provided. The system includes a movable window, a trim panel, a seal, and a below belt member. The trim panel defines a first channel extending along a channel axis. The seal is partially mounted within the first channel with the seal including an exterior sealing lip at least partially, disposed between the movable window and the trim panel with the exterior sealing lip having an exposed surface to form a flush connection between an outer surface of the movable window and an exterior surface of the trim panel. The below belt member is formed separately from the trim panel with the below belt member defining a second channel extending along the channel axis. The movable window is disposed within the second channel prior to the first channel receiving the movable window to ease installation so as to reduce time during assembly.

### CROSS-REFERENCE TO RELATED APPLICATIONS

This application claims priority to and all the benefits of U.S. Provisional Patent Application No. 63/351,570, filed Jun. 13, 2022; Chinese Utility Model Application No. 202221229420.3, filed May 18, 2022; Chinese Utility Model Application No. CN202221250924.3, filed May 18, 2022; and Chinese Utility Model Application No. CN202221229280.X, filed May 18, 2022, each of which is hereby incorporated by reference in its entirety.

### FIELD OF THE INVENTION

The present disclosure relates, generally, to flush glass systems and, more specifically, to flush glass systems including a trim panel defining a channel for guiding movement of a window.

### BRIEF DESCRIPTION OF THE DRAWINGS

Advantages of the present disclosure will be readily appreciated as the same becomes better understood by reference to the following detailed description when considered in connection with the accompanying drawings. Exemplary illustrations are shown in detail. Although the drawings represent schematic configurations, the drawings are not necessarily to scale and certain features may be exaggerated to better illustrate and explain an innovative aspect of an illustrative configuration. Further, the exemplary illustrations described herein are not intended to be exhaustive or otherwise limiting or restricting to the precise form and configuration shown in the drawings and disclosed in the following detailed description.

FIG. 1 is a partial side view of an exemplary vehicle including front and rear passenger vehicle doors having windows.

FIG. 2A is a partial schematic perspective view of a flush glass system including a trim panel and window, with the window arranged in a closed position.

FIG. 2B is a partial schematic perspective view of the flush glass system of FIG. 2A, with the window moved toward an open position.

FIG. 2C is partial schematic perspective view of the flush glass system of FIG. 2A, with the window moved to the open position.

FIG. 3 is a schematic perspective view of the trim panel of FIGS. 2A-2C.

FIG. 4 is a left-side schematic perspective view of the trim panel of FIGS. 2A-2C.

FIG. 5 is an enlarged partial schematic perspective view taken at reference 5 in FIG. 4.

FIG. 6 is a rear schematic perspective view of the trim panel of FIGS. 2A-2C.

FIG. 7 is a partial schematic sectional view of the trim panel taken along line 7-7 in FIG. 6.

FIG. 8 is a partial perspective view of the flush glass system, with the window in the closed position.

FIG. 9 is a cross-sectional view of the flush glass system with a glass pane removed.

FIG. 10 is a perspective view of the trim panel with a seal disposed therein.

FIG. 11 is a perspective view of the trim panel with the seal removed.

FIG. 12 is a perspective view of a portion of the trim panel.

FIG. 13 is a perspective view of the seal.

FIG. 14 is a perspective view of a guide structure of the window that engages the seal disposed within the trim panel.

FIG. 15 is a perspective view of a below belt member.

FIG. 16 is a partially perspective view of the flush glass system illustrating an opposing edge of the window from the trim panel.

FIG. 17 is a perspective view of a trim member with a trim member seal.

FIG. 18 is a perspective view of the trim member.

FIG. 19 is a perspective view of a second guide structure of the window that engages the trim member seal disposed within the trim member.

FIG. 20 is a side view of a guide structure of a movable window in accordance with an alternative embodiment.

FIG. 21 is a cross-sectional side view of an alternative flush glass system incorporating the guide structure of FIG. 20.

FIG. 22 is a cross-sectional side view of the flush glass system of FIG. 21 with a window and seal removed.

FIG. 23 is a side view the seal of the flush glass system of FIG. 21.

FIG. 24 is a partial perspective view of the window and the guide structure of the window for the flush glass system of FIG. 21.

FIG. 25 is a side view of a guide structure of a movable window in accordance with another alternative embodiment.

FIG. 26 is a cross-sectional side view of another alternative flush glass system incorporating the guide structure of FIG. 25.

FIG. 27 is a cross-sectional side view of the flush glass system of FIG. 26 with a window and seal removed.

FIG. 28 is a side view the seal of the flush glass system of FIG. 26.

FIG. 29 is a partial perspective view of the window and the guide structure of the window for the flush glass system of FIG. 26.

FIG. 30 is a side view of a guide structure of a movable window in accordance with yet another alternative embodiment.

FIG. 31 is a cross-sectional side view of yet another alternative flush glass system incorporating the guide structure of FIG. 30.

FIG. 32 is a side view the seal of the flush glass system of FIG. 31.

FIG. 33 is a side view of a trim panel of the flush glass system of FIG. 31.

### DETAILED DESCRIPTION

It is to be understood that the invention may assume various alternative orientations, except where expressly specified to the contrary. It is also to be understood that the specific devices and processes illustrated in the attached drawing, and described in the following specification are simply exemplary configurations of the inventive concepts defined in the appended claims. Hence, specific dimensions and other physical characteristics relating to the configurations disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

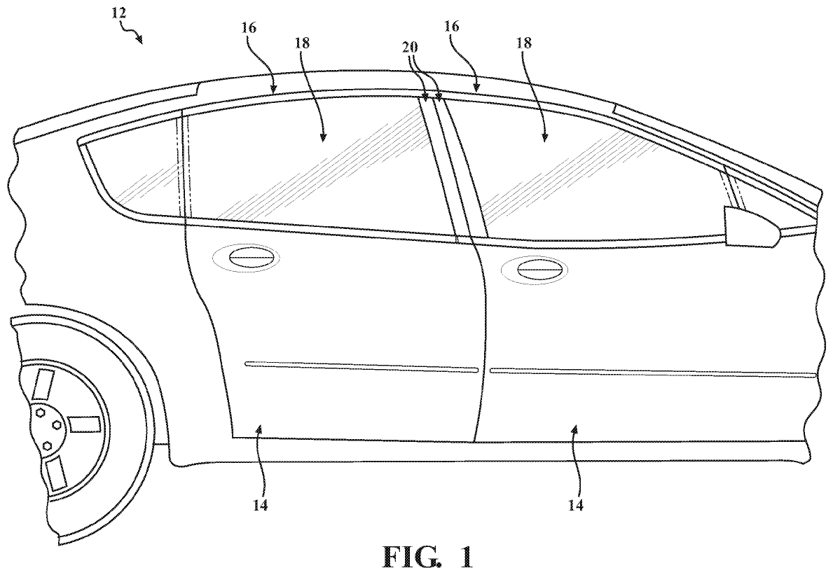

Referring now to the Figures, wherein like numerals indicate corresponding parts throughout the several views, configurations of a flush glass system 10 are shown through the Figures and are described in detail below. The flush glass system 10 is configured for use in a vehicle 12, such as a passenger car, truck, or other transportation vehicle. As shown in FIG. 1, the vehicle 12 includes a plurality of doors 14. Specifically shown are the front and rear passenger doors. Each door 14 has a frame 16 (may also be referred to as a door frame) defining at least one window opening. It will be appreciated that the frame 16 may include a plurality of frame members or plates. A movable window 18 (may also be referred to as a glass window 18 or window 18) is positioned within the window opening of each door 14. The movable window 18 is movable between open and closed positions relative to the frame 16 of each door 14.

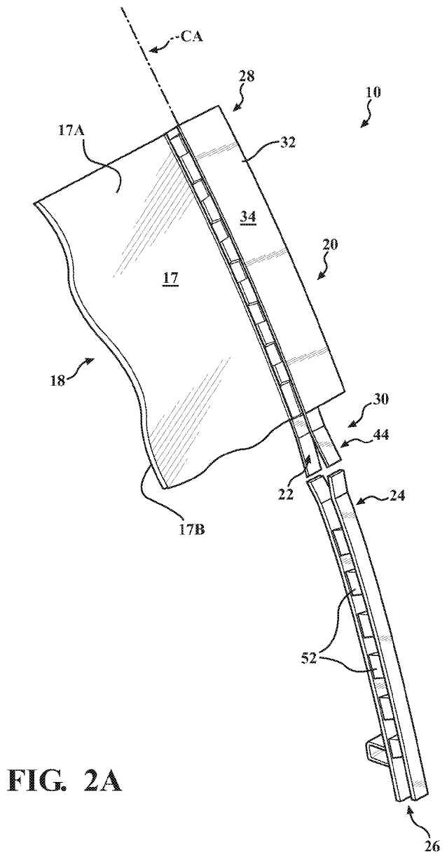

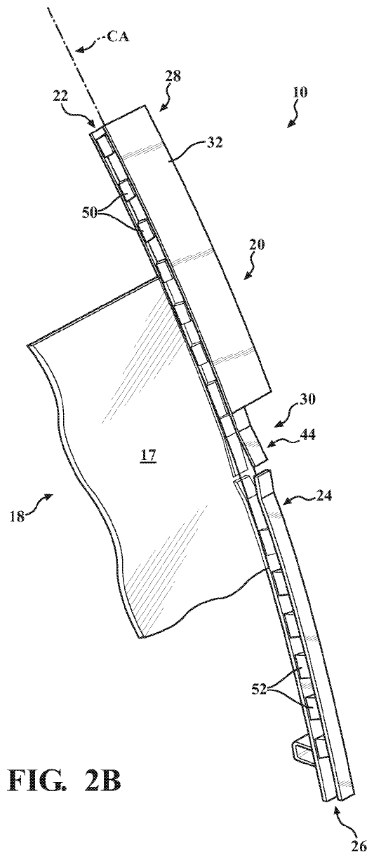

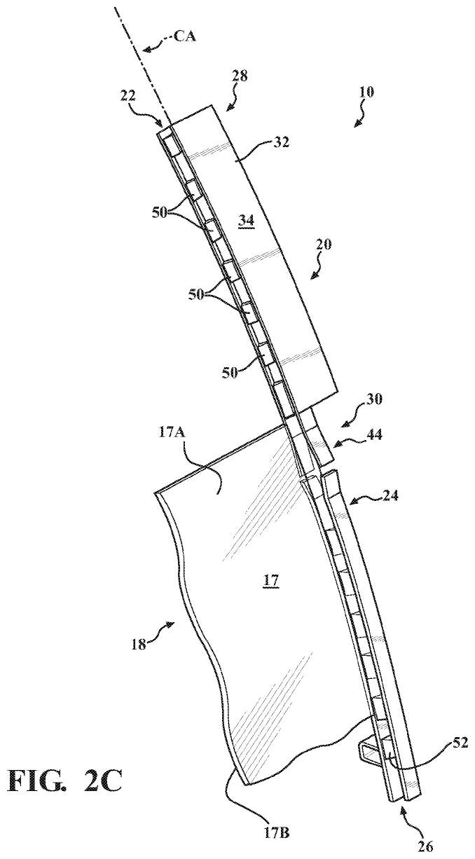

As shown in FIGS. 2A-2C, 8, 16, 21, 26, and 31, the movable window 18 includes an outer surface 17A, and inner surface 17B, and edges 17C bounding the window 18. It will further be appreciated that the window 18 includes a glass pane 17 (which may be referred to herein as a glass piece), and a guide structure 19 (which may be referred to herein as a sliding arm 19 or sliding block structure) coupled to the glass pane 17. The glass pane 17 further defines the outer surface 17A, inner surface 17B, and edges 17C. In the configurations shown, the guide structure 19 is coupled to the inner surface 17B of the glass pane 17 and is movable with the glass pane 17 as the window 18 moves between the open and closed positions. As described herein, the phrase “movable window” includes the glass pane (or glass piece) and the guide structure (or sliding arm or sliding block structure) coupled to the glass pane with both the glass pane and guide structure movable as a unit. The guide structure 19 will be discussed in greater detail below.

When the window 18 is closed or in the closed position, its outer surface is adapted to be flush with an exterior of the vehicle 12 and/or an exterior surface 34 of an adjacent element (such as a trim panel or applique). As described here, the term “flush” herein is to be interpreted as meaning that there is little to no substantial perception of a level difference between surfaces at least from a visual point of view. In cases related to vehicles, the movable window 18, in the closed position, is “flush” with the upper and/or lateral body parts that bound a window opening to be closed by the window 18. Thus, when viewed from the outside, the window 18 appears not to be set back with respect to the vehicle door 14 or door parts (such as the trim panel or applique) and/or another window 18 when it is completely closed. Rather, the impression of a continuous, planar pane and body surface is created on the exterior side of the vehicle 12. It is to be appreciated that these components may not be completely on the same plane, and some parts (such as a part of the seal) may protrude slightly. While the vehicle 12 of FIG. 1 is an example application suitable for the flush glass system 10, the present design is not limited to vehicular applications. Any stationary or mobile, machine or manufacture may benefit from use of the present design, when properly scaled and configured for the particular application.

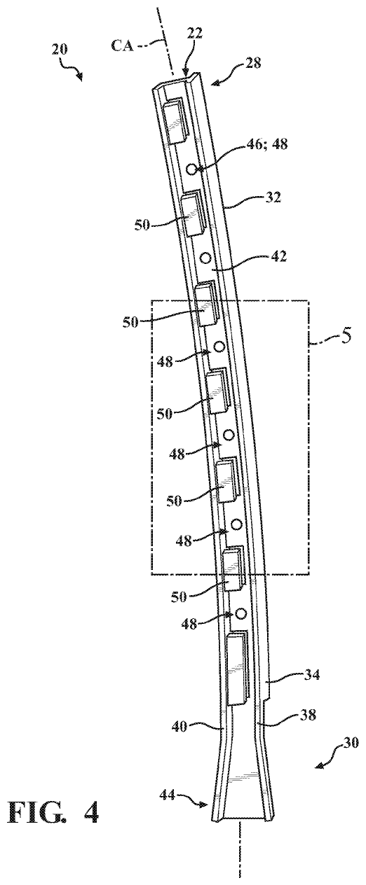

Referring to schematic FIGS. 2A-4, the flush glass system 10 includes a trim panel 20 defining a first channel 22 extending along a channel axis CA as disclosed herein. As shown in these figures, the flush glass system 10 is installed in a rear passenger door. The channel axis CA may be curved or straight depending on the desired design. As known in the industry, this type of trim panel 20 is also known as an applique. An applique often has a decorative exterior appearance. The first channel 22 is configured to receive a seal (discussed below) to guide movement of the window 18 as it moves between the closed position (see FIG. 2A) and the open position (see FIGS. 2B and 2C) and vice-versa. The first channel 22 is integral with the trim panel 20. In other words, the trim panel 20 and the first channel 22 are integral components with the first channel 22 extending along the extension of the trim panel 20 or at least a portion of the trim panel 20. With the first channel 22 being integral with the trim panel 20, an optimized fit and assembly of a portion of the window 18 relative to the trim panel 20 are achieved. As mentioned above and discussed in greater detail below, the movable window 18 preferably has a guide structure 19 received within the first channel 22 to guide the window during movement.

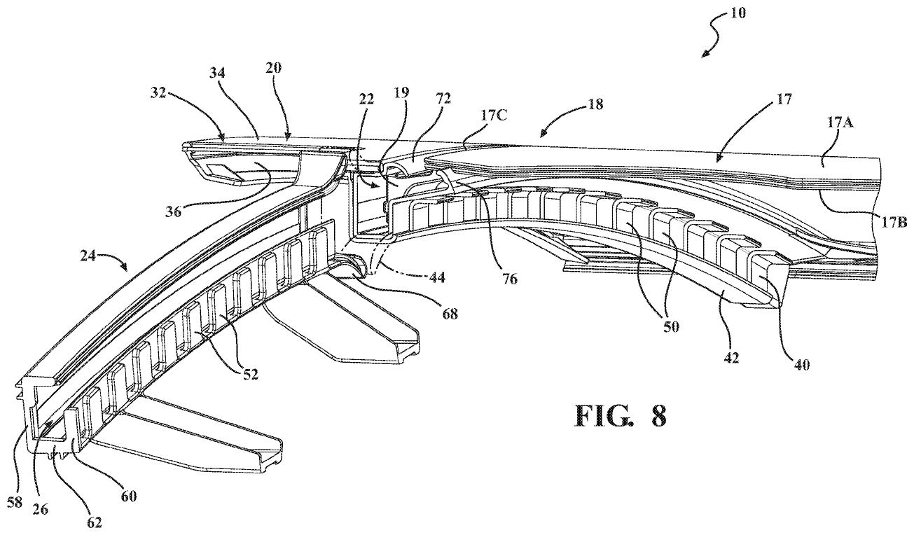

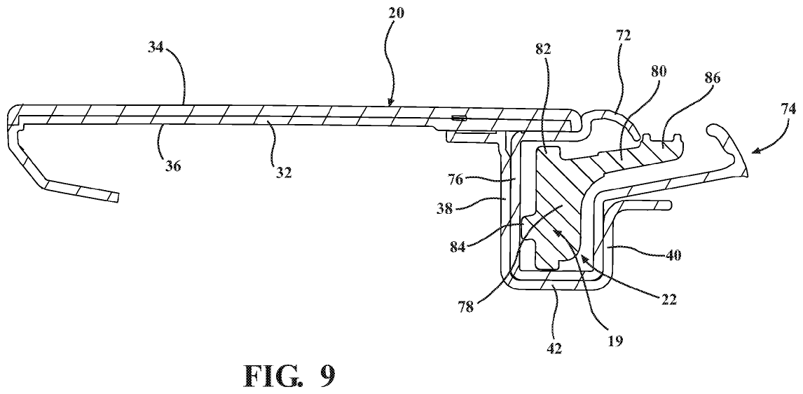

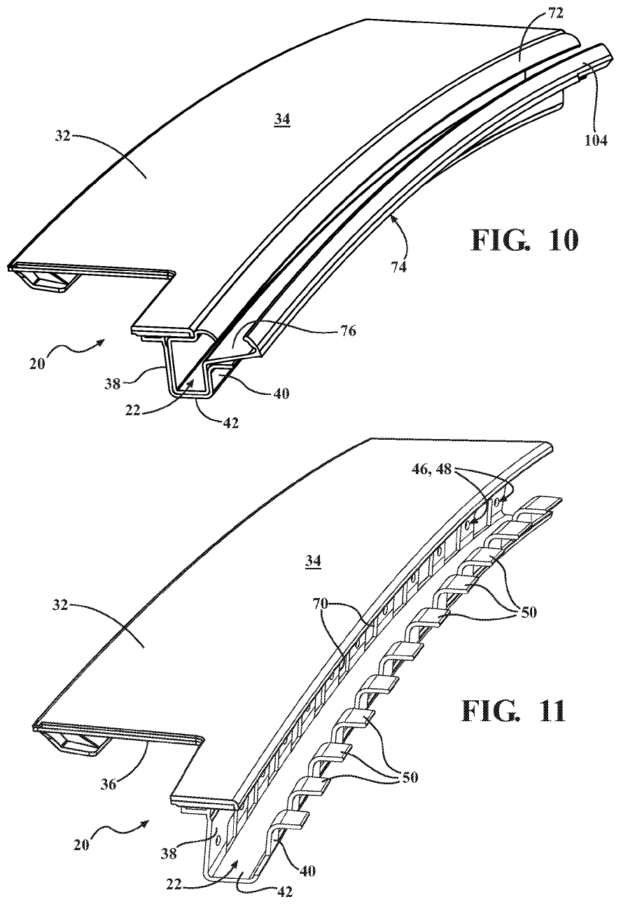

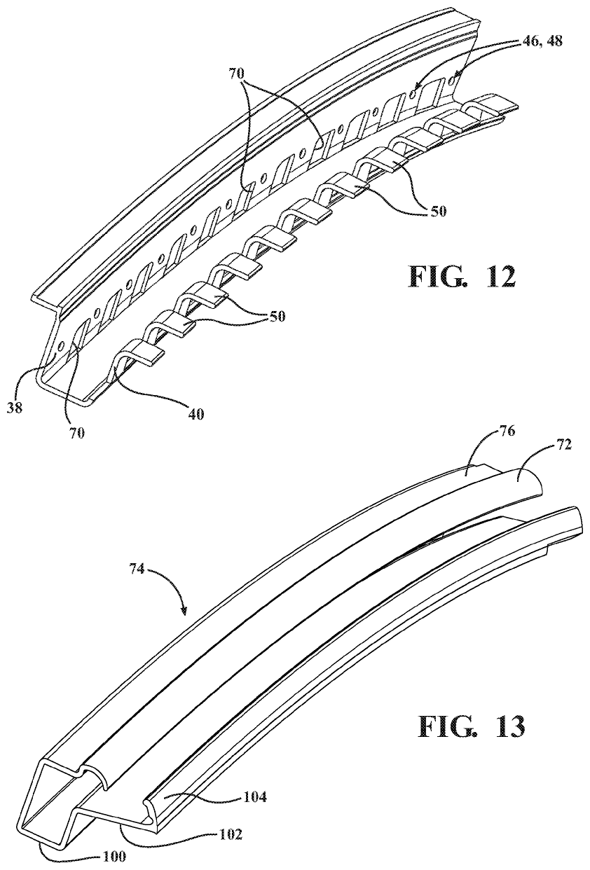

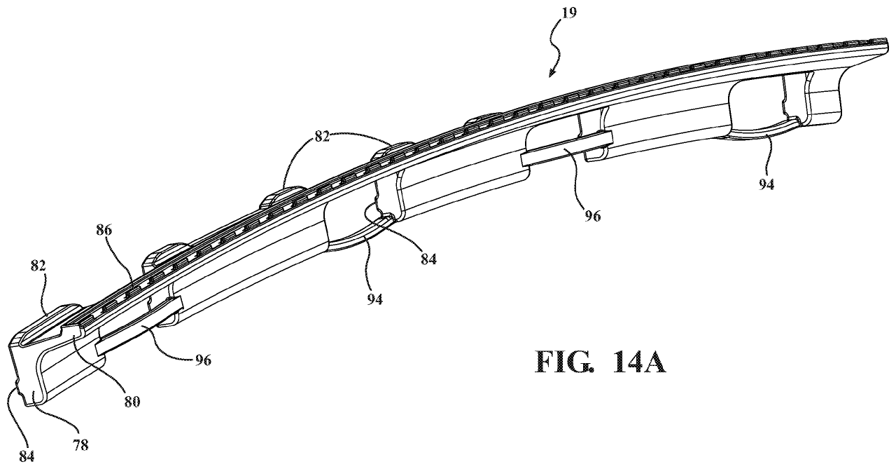

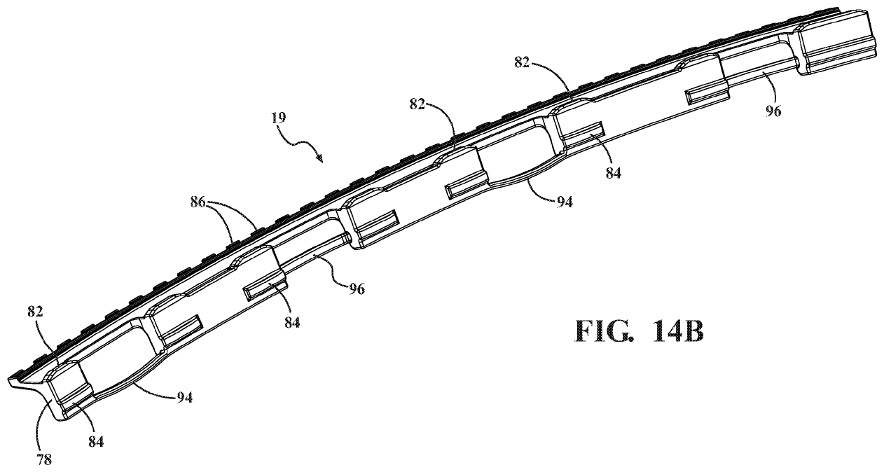

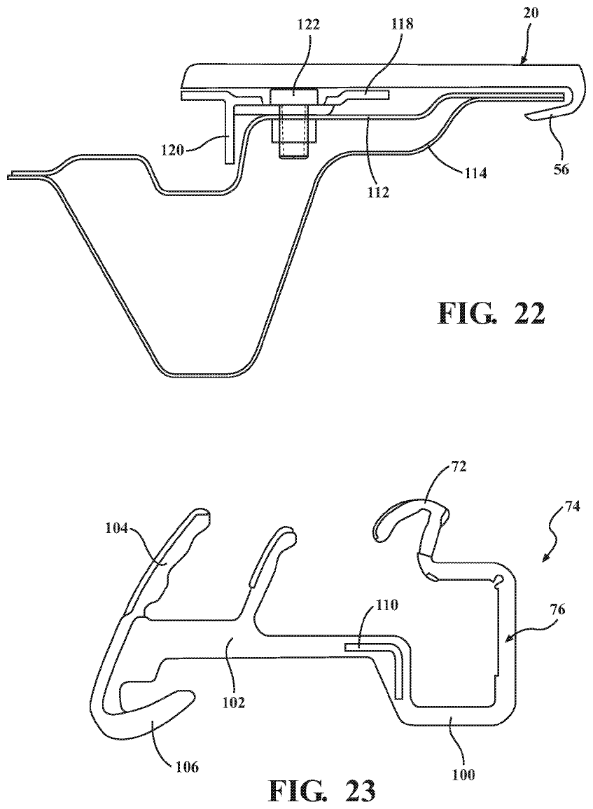

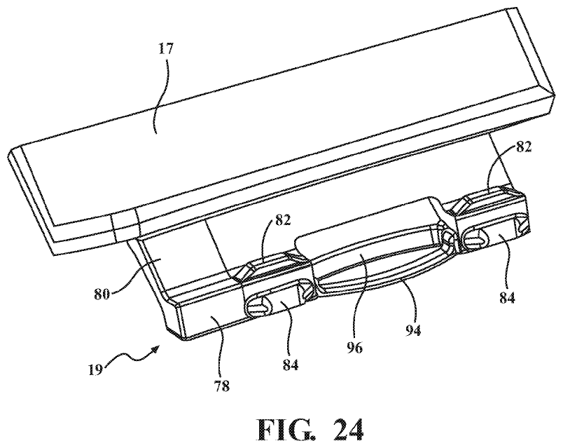

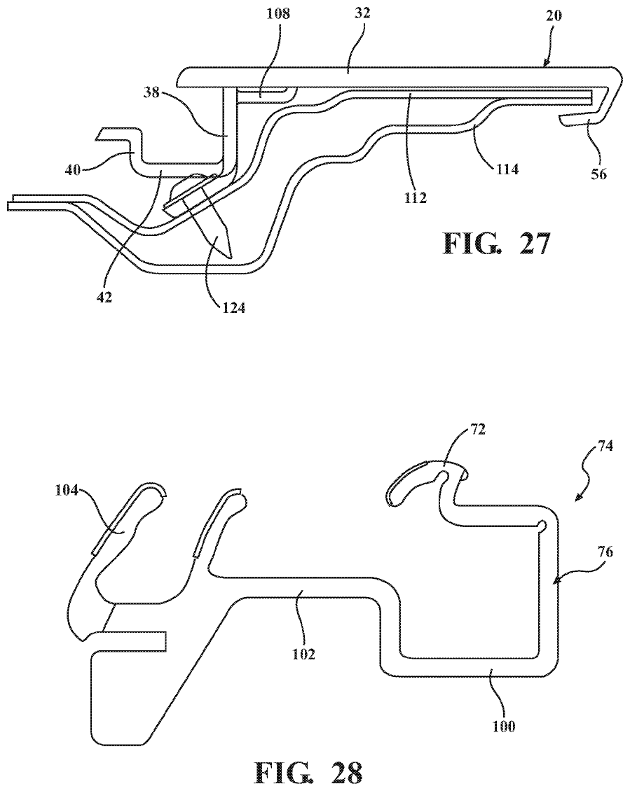

Referring also to FIGS. 8-14 and 20-31, the flush glass system 10 further includes a seal assembly 74 including a seal 76 configured to aid in protecting the interior of the vehicle 12 from the external environment. As shown in these figures, the flush glass system 10 is installed in a front passenger door. It is to be appreciated that this type of flush glass system can be installed in any suitable location on the vehicle. The first channel 22 is shaped to receive the seal assembly and the seal assembly includes an exterior sealing lip 72 to seal about an edge of the window 18. In the preferred embodiment as shown, the seal is partially mounted within the first channel 22 of the trim panel. Even more preferably, the seal is only mounted within the first channel 22. It is also contemplated that the first channel 22 may include an integrated seal assembly formed directly on portions of the channel, rather than a separate insertable seal assembly. The seal assembly 74 will be discussed in greater detail below.

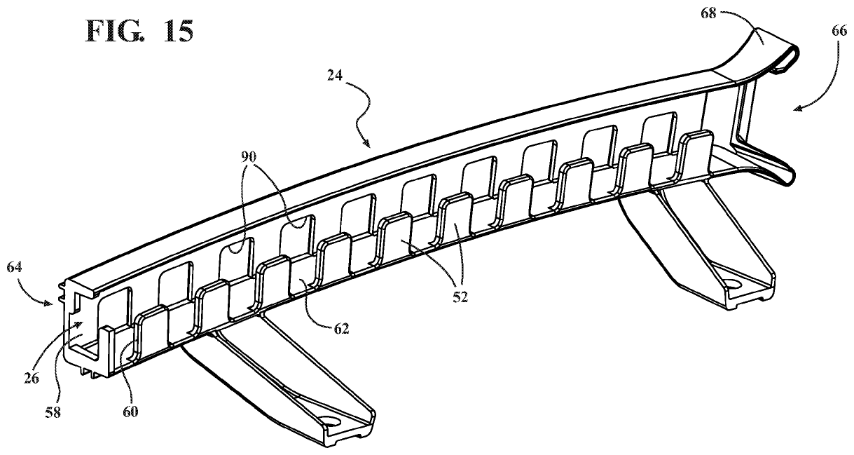

As shown in FIGS. 2A-2C, 8, and 15-16, the flush glass system 10 further includes a below belt member 24 disposed in the door 14 with the below belt member 24 defining a second channel 26 extending along the channel axis CA. The second channel 26 is configured to guide the guide structure 19 of the window 18 as the window 18 moves between the open and closed positions. In this way, the window 18 is guided along the channel axis CA as it travels upwardly and downwardly between the open and closed positions. The first channel 22 of the trim panel 20 and the second channel 26 of the below belt member 24 continues at least partially along the vertical extent of the vehicle 12 from an upper end 28 to a lower end 30 of the vehicle 12. It will be appreciated that, although the first channel 22 and the second channel 26 are described herein as being the “first” and “second” channels, the particular order of the channels may be varied, and the terms in the phrases “first channel” and “second channel” are merely used to distinguish the channel from other channels, not to indicate any particular significance to its sequential order.

The below belt member 24 further includes an outer branch 58 (also referred to as an outer member or outer portion) and an inner branch 60 (also referred to as an inner member or inner portion) spaced from and connected to one another by a base 62 (also referred to as a base member or base portion). The outer branch 58, inner branch 60, and base 62 of the below belt member 24 further define the second channel 26. The outer branch 58 extends at least partially or, in some configurations, substantially parallel to the inner branch 60. The outer branch 58 and inner branch 60 extend at least partially or, in some configurations, substantially parallel to each other in the vertical extent of the vehicle 12. The outer branch 58 and inner branch 60 extend from a lower end 64 to an upper end 66 of the below belt member 24 in the vertical direction of the vehicle 12.

The outer branch 58 and the inner branch 60 of the below belt member 24 extend from the lower end 64 to a flared portion 68 at the upper end 66 of the below belt member 24. The flared portion 68 is flared such that the second channel 26 is widened at the upper end 66 of the below belt member 24. It will be appreciated that the second channel 26 may be configured to fan-out, flare, or otherwise widen at the upper end 66 of the below belt member 24. The below belt member 24 is orientated so that the flared portion 68 is facing towards the trim panel 20. The flared portion 68 ensures the window 18 is properly guided between the first channel 22 of the trim panel 20 and the second channel 26 of the below belt member 24. In some configurations, the flared portion 68 is integral with the outer and inner branches 58, 60 such that the outer and inner branches 58, 60 flare or transitions outwards at the upper end 66 of the below belt member 24. In such configurations, the outer and inner branches 58, 60 extend substantially parallel to each other, and, at the flared portion 68, the outer and inner branches 58, 60 extend away or outwards from each other. In other words, the second channel 26, as partially defined by the outer and inner branches 58, 60, may gradually widen at the upper end 66 of the below belt member 24. In some configurations, the flared portion 68 is a separate component coupled to at least one of the outer and inner branches 58, 60. In these configurations, the flared portion 68 may couple to at least one of the outer and inner branches 58, 60 via adhesive bonding, welding, mechanical fastening, or any other suitable method. Other configurations are contemplated. It will be appreciated that the flared portion 68 may be integral to or coupled to both or one of the outer and inner branches 58, 60. It will further be appreciated that the flared portion may, in some configurations, include a section that tapers or otherwise narrow to ensure the window 18 is properly guided between the first channel 22 of the trim panel 20 and the second channel 26 of the below belt member 24.

The inner branch of the below belt member 24 further includes a plurality of projections 52 defining alternating slots. The projections 52 may include a flat upper surface to aid in supporting the guide structure 19 of the window 18 as the guide structure 19 is disposed within the second channel 26. A second seal is inserted into the second channel 26 with a portion of the second seal abutting the projections 52 and otherwise occupying the second channel 26. Preferably, the second seal is only mounted to the second channel. Generally, the projections 52 are shown to be of rectangular shape. It will be appreciated that the shape of the projections 52 in FIGS. 2A-2C are shown generically and/or schematically with a more particular configuration shown in FIGS. 8 and 15-16. The projections 52 may have any suitable shape and/or configuration. It will further be appreciated that the projections 52 may be any type of component that facilitates at least one of guiding, locating, and retaining such as, but not limited to, a tab, flap, extension, protrusion, lip, fingers, flange, and the like.

The outer branch of the below belt member 24 further includes a plurality of second passageways 90. The passageways are preferably aligned with the projections 52.

The first channel 22 of the trim panel 20 and the second channel 26 of the below belt member 24 allows the movement of the guide structure 19 of the window 18 to be continuous through trim panel 20 and the below belt member 24 which results in improved window 18 guiding and mounting as well as reduction in assembly time. The first channel 22 of the trim panel 20 and the second channel 26 of the below belt member 24 both extend along the channel axis CA. In other words, the first channel 22 and the second channel 26 are aligned to guide the guide structure of the window 18 between the trim panel 20 and the below belt member 24 as the window 18 moves from the closed position to the open position and vice-versa. Said differently, the trim panel 20 and the below belt member 24 are aligned with each other such that the channel axis CA of the first channel 22 is aligned with (e.g., parallel with or coincidental with) a channel axis CA of the second channel 26. It will be appreciated that the channel axis CA may curve or bend to correspond to the curvature of the vehicle 12.

For purposes of clarity and consistency, certain structural features described below are not separately illustrated in FIGS. 2A-2C, but can be found in other Figures. FIGS. 2A-2C illustrate operation of the movable window 18, with FIG. 2A depicting the window 18 is disposed within the first channel 22 of the trim panel 20 and arranged in the closed position to illustrate a scenario where the window 18 is closed. In FIG. 2B, the window 18 is shown as having lowered or moved along the channel axis CA to illustrate a scenario where the window 18 is being moved from the closed position towards an open position to at least partially expose the interior of the vehicle 12 to the external environment. Here, a portion of the guide structure of the window 18 is still disposed within the first channel 22 of the trim panel 20 with another portion of the guide structure of the window 18 being disposed within the second channel 26 of the below belt member 24. The alignment of the first and second channels 22, 26 allow the movement of the guide structure of the window 18 to be continuous as the guide structure of the window 18 enters the second channel 26 of the below belt member 24. In FIG. 2C, the window 18 is shown as having lowered or moved further along the channel axis CA to illustrate a scenario where the window 18 is in another open position, different from the open position in FIG. 2B, to further expose the interior of the vehicle 12 to the external environment. Here, a greater portion, as compared to FIG. 2B, of the guide structure of the window 18 is disposed within the second channel 26 of the below belt member 24. The extent of the first and second channels 22, 26 are sufficient to provide a selected degree of movement for the guide structure of the window 18. Though not shown here, it will be understood that a mechanism may be provided in connection with the vehicle door 14 for raising and lowering the window 18.

In the preferred configuration, the trim panel 20 and the below belt member 24 are formed as separate components. Said differently, the below belt member 24 is formed separately from the trim panel 20. In such configurations, the trim panel 20 and the below belt member 24 may be formed by separate molding steps or operations. The trim panel 20 and the below belt member 24 are configured to be separately mounted to the vehicle door 14, more specifically, the frame 16 of the door 14. As mentioned above, the first channel 22 of the trim panel 20 and the second channel 26 of the below belt member 24 allows the movement of the window 18 to be continuous through trim panel 20 and the below belt member 24 which results in improved window 18 guiding and mounting as well as reduction in assembly time. With the trim panel 20 and the below belt member 24 being formed separately and mounted separately during assembly of the door 14, in some configurations, the below belt member 24 is mounted to the door 14 first. Once the below belt member 24 is mounted, the guide structure of the window 18 is disposed within the second channel 26 of the below belt member 24. In this way, the guide structure of the window 18 may be easily slid down the second channel 26 during assembly. After, the trim panel 20 is mounted to the door 14. The guide structure of the window 18 is disposed within the second channel 26 of the below belt member 24 prior to the first channel 22 of the trim panel 20. In this way, the time to install of the window 18 is reduced during assembly.

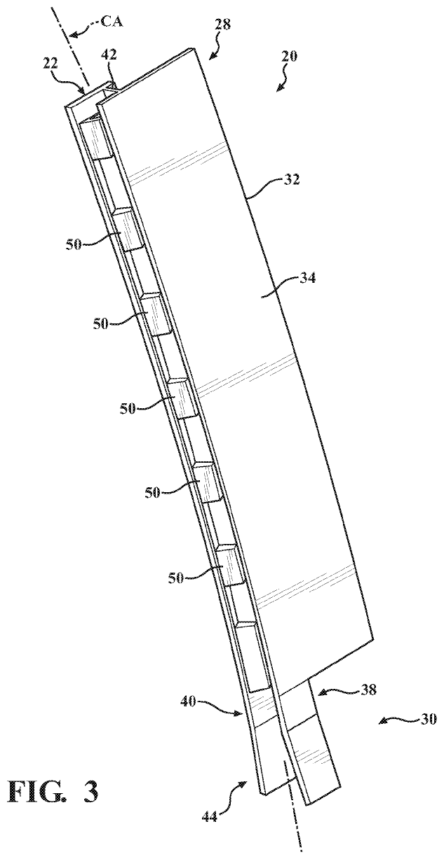

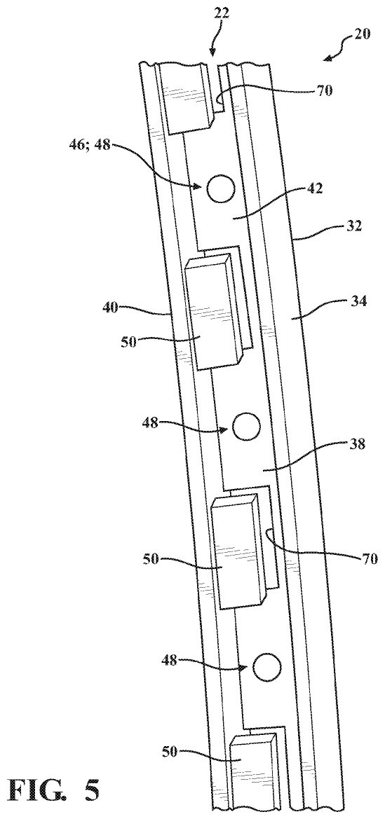

Referring now to FIGS. 3-6 and 8-12 the trim panel 20 is discussed in greater detail. The trim panel 20 is a generally elongated structure having a first or upper end 28 and a second or lower end 30. The trim panel 20 includes an exterior member 32. The exterior member 32 may have various finishes such as low gloss black, high glass black, and chrome. As mentioned above, the trim panel 20 and/or exterior member 32 are also known as an applique. The exterior member 32 includes an exterior surface 34 intended to be facing towards the exterior of the vehicle 12 and an interior surface 36 intended to be facing towards the interior of the vehicle 12. The exterior surface 34 of the exterior member 32 is visible from the exterior of the vehicle 12. The trim panel 20 and the movable window 18 may appear and/or form a flush connection therebetween. It is contemplated that the trim panel 20 and the window 18 may be arranged in any configuration such that the exterior surface 34 of the exterior member 32 of the trim panel 20 and the window 18 form a flush connection. The term “flush” is described above.

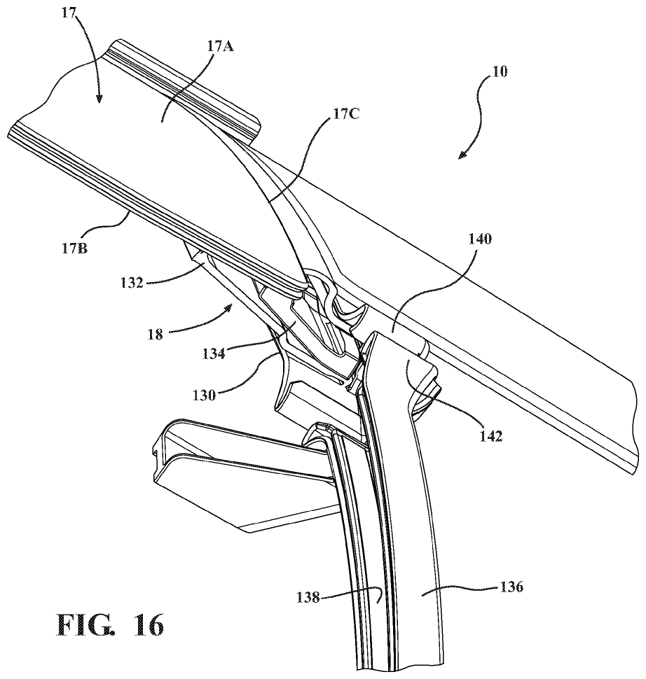

The glass pane 17 of the moveable window 18 is spaced from the exterior member 32 of the trim panel 20 for form a gap or space between the exterior member 32 and an edge of the glass pane 17. The gap is illustrated schematically in FIGS. 2A-2C and in more detail in FIGS. 8 and 16. The exterior sealing lip 72 of the seal 76 is disposed within the gap to seal the window 18 from the elements as discussed in greater detail below.

The trim panel 20 further includes an outer branch 38 (also referred to as an outer member, outer portion, or connecting plate) and an inner branch 40 (also referred to as an inner member, inner portion, or connecting plate) spaced from and connected to one another by a base 42 (also referred to as a base member, base portion, or connecting plate). In some configurations, the outer branch 38 couples to the inner surface of the exterior member 32. In other configurations, the outer branch 38 couples to a connecting bracket 108 which couples to the exterior member 32. The outer branch 38 extends at least partially or, in some configurations, substantially parallel to the inner branch 40. The outer branch 38 and inner branch 40 extend at least partially or, in some configurations, substantially parallel to the exterior member 32 in the vertical direction of the vehicle 12. The outer branch 38 and inner branch 40 extend from the upper end 28 to the lower end 30 of the trim panel 20 in the vertical direction of the vehicle 12. In some configurations, the outer branch 38 and the inner branch 40 extend past the exterior member 32. It is contemplated that the outer and inner branches 38, 40 may extend past the exterior member 32 in any direction. It will be appreciated that the outer branch 38, the inner branch 40, and the base 42 may be referred to herein as a connecting plate in some configurations. It will further be appreciated that the trim panel 20 may include any number of connecting plates.

The outer branch 38, inner branch 40, and base 42 of the trim panel 20 further define the first channel 22. It is contemplated that, in some configurations, the outer branch 38 may be integral with the exterior member 32 such that the exterior member 32, the inner branch 40, and the base 42 further define the first channel 22. In the illustrated configurations, the first channel 22 is substantially “U” shaped and extends along the trim panel 20 from the upper end 28 to the lower end 30 of the trim panel 20. Notably, the shape of the first and second channels 22, 26 are shown generically and/or schematically, and the “U” shape of the first channel 22 and the second channel 26 may not necessarily be a perfect shaped “U.” Alternatively, the first and second channels 22, 26 may have any suitable shape and/or configuration.

The trim panel 20 includes a flared portion 44 wherein the lower end 30 of the trim panel 20 is flared such that the first channel 22 is widened at the lower end 30 of the trim panel 20. The flared portion 44 is shown in FIGS. 2A-4 and 6, and is shown in phantom in FIG. 8. In the preferred embodiment, the flared portion 44 has a complementary configuration to the flared portion 68 of the below belt member 24. It will be appreciated that the first channel 22 may be configured to fan-out, flared, or otherwise widen at the lower end 30 of the trim panel 20. The trim panel 20 is orientated so that the flared portion is facing towards the below belt member 24. More specifically, the trim panel 20 is orientated so that the flared portion 44 of the trim panel 20 is facing towards the flared portion 68 of the below belt member 24. The flared portions 44, 68 ensures the window 18 is properly guided between the first channel 22 of the trim panel 20 and the second channel 26 of the below belt member 24. In some configurations, the flared portion 44 is integral with the outer and inner branches 38, 40 such that the outer and inner branches 38, 40 flare or transitions outwards at the lower end 30 of the trim panel 20. In such configurations, the outer and inner branches 38, 40 extend substantially parallel to each other, and, at the flared portion 44, the outer and inner branches 38, 40 extend away from each other. In other words, the first channel 22, as partially defined by the outer and inner branches 38, 40, may gradually widen at the lower end 30 of the trim panel 20. Further, in such configurations, the outer and inner branches 38, 40 may extend obliquely relative to the exterior member 32. While in other configurations, the flared portion 44 is a separate component coupled to at least one of the outer and inner branches 38, 40. In these configurations, the flared portion 44 may couple to at least one of the outer and inner branches 38, 40 via adhesive bonding, welding, mechanical fastening, or any other suitable method. Other configurations are contemplated. It will be appreciated that the flared portion 44 may be integral to or coupled to both or one of the outer and inner branches 38, 40. It will further be appreciated that the flared portion 44 may, in some configurations, include a section that tapers or otherwise narrow to ensure the window 18 is properly guided between the first channel 22 of the trim panel 20 and the second channel 26 of the below belt member 24.

The outer portion of the trim panel 20 further includes the outer branch having a mounting feature 46. The mounting feature 46 defines alternating passageways along the outer branch. A mounting feature is defined herein as a feature that facilitates mounting of the trim panel 20 to the vehicle door 14, such as the frame 16, or any component of the vehicle 12. The mounting feature 46 is associated with the first channel 22 of the trim panel 20. The mounting feature 46 accommodates any type of fastener or the like while providing a clearance for the guide structure of the window 18 to move along the channel axis CA between the close and open positions without any obstructions. For instance, in some configurations the mounting feature 46 may define one or more holes 48 shaped to accommodate a fastener (not shown) or the like. A fastener may extend through the hole to mount the trim panel 20 to the frame 16 of the vehicle door 14 or any other component of the vehicle. The fastener may be any type of fastener(s) or fastening mechanism, which may include but are not limited to nails, bolts, screws, and clips. In some configurations, the mounting feature 46 may form one or more recesses shaped to facilitate mounting of the trim panel 20 to the vehicle door 14. The mounting feature 46 may include any number of openings, holes, recesses, or combinations thereof. The opening, holes, and/or recesses of the mounting feature 46 may be spaced from each other and formed along the outer branch to couple the outer portion and the entire trim panel to the frame 16 or any component of the vehicle 12.

The inner branch of the trim panel 20 further includes a plurality of spaced projections 50 defining alternating slots. Generally, the projections 50 are shown to be of rectangular shape. It will be appreciated that the shape of the projections 50 in FIGS. 2A-5 are shown generically and/or schematically with a more particular illustration of the projections 50 being shown in FIGS. 8-12. The rectangular shape of the projections 50 may not necessarily be rectangular. The projections 50 may have any suitable shape and/or configuration. It will further be appreciated that the projections 50 may be any type of component that facilitates at least one of guiding, locating, and retaining such as, but not limited to, a tab, flap, extension, protrusion, lip, fingers, flange, and the like.

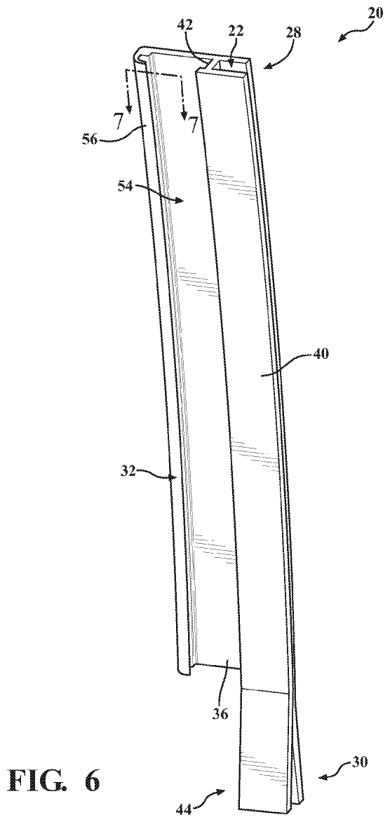

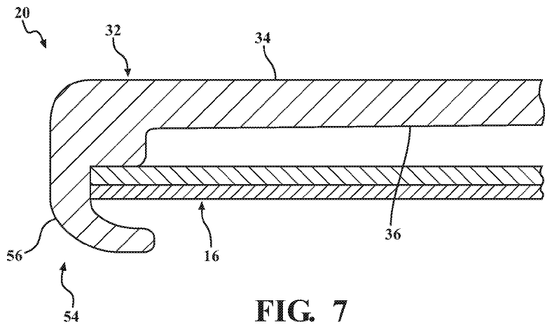

Referring to FIGS. 6 and 7, the trim panel 20 can include an attachment feature 54. This attachment feature 54 is optional and is defined herein as a feature that facilitates attachment of the exterior member 32 of the trim panel 20 to the vehicle door 14. Here, the attachment feature 54 is illustrated schematically and positioned relative to the interior surface 36 of the trim panel 20. Although the attachment feature 54 is depicted on the interior surface 36 of the exterior member 32, it will be appreciated that the attachment feature 54 may be positioned relative to any component of the trim panel 20. In some configurations, the attachment feature 54 is integral with the exterior member 32 of the trim panel 20. The attachment feature 54 may include any type of attachment member, such as, but not limited to, a snap, hook, clamp, clip, or adhesive. The vehicle door 14 including any component of the vehicle door 14 may be at least partially interposed between the exterior member 32 and the attachment feature 54 to facilitate attachment of the trim panel 20 to the vehicle door 14. For instance, in some configurations, the attachment feature 54 includes a hook portion 56 (best shown in FIG. 7) extending from the exterior member 32. More specifically, the hook portion 56 (which may be referred to herein as a bending portion) extends from an edge of the exterior member 32 and at least partially curves towards the base 42. The hook portion 56 may be dimensioned and/or shaped to receive an edge or portion of the frame 16 of the vehicle door 14 to secure the trim panel 20 to the vehicle door 14 or any component of the vehicle 14, such as the frame 16. The hook portion 56 may receive the edge or portion of the frame 16 such that the frame 16 is interposed between the hook portion 56 and the interior surface 36 of the exterior member 32. In this way, the trim panel 20 may be securely attached to the vehicle door 14. It is to be appreciated that having a hook portion 56 as shown is optional. The attachment feature 54 may be used to align the trim panel 20 relative to the below belt member 24 in a manner similar to that shown and described above. It will be appreciated that the attachment feature 54 may be a continuous or segmented feature extending along the trim panel 20. It will further be appreciated that FIGS. 6 and 7 depict an exemplary configuration of the attachment feature 54. Other configurations of the attachment feature 54 are contemplated.

The present disclosure also includes a method of installation of the flush glass system 10. A disadvantage of certain installations is the number of components required to be fastened together and installed into the vehicle door. Having to fasten together multiple components and then mounting the components to the vehicle door increases the assembly time. Additionally, another disadvantage of certain installations is that sometimes the trim panel(s) and below belt member(s) are formed together and must be assembled at the same time, which makes installing the glass pane time consuming and difficult. In particular, parts of the trim panel and/or the below belt member must be bent or manipulated in a way in order to slide the glass pane down a channel of the trim panel and/or a channel of the below belt member. Having to do so further increases the assembly time. The flush glass system 10 described herein solve these disadvantages and reduces the assembly time.

To install the flush glass system 10, the method of installation includes the steps of mounting the below belt member 24 to the vehicle door 14 and sliding the guide structure 19 of the movable window 18 downwards along the second channel 26 of the below belt member 24. Once the movable window 18 is installed, the method includes the steps of positioning the trim panel 20 adjacent to the below belt member 24 and simultaneously sliding the guide structure 19 of the movable window along the first channel such that the first channel of the trim panel is aligned with the second channel of the below belt member. The trim panel 20 is then mounted to the vehicle door 14. To position the trim panel 20, in some configurations, the method includes the step of positioning the flare portion 44 of the trim panel 20 towards and adjacent to the below belt member 24 to aid in the alignment of the first channel 22 and the second channel 26 along the channel axis CA. In some configurations, the method includes the step of positioning the flare portion 68 of the below belt member 24 towards an upper end of the vehicle door 14. As shown throughout the Figures, the trim panel 20 is arranged such that the flared portion 44 of the trim panel 20 is facing towards the flared portion 68 of the below belt member 24. In this way, the first channel 22 of the trim panel 20 is aligned with the second channel 26 of the below belt member 24 to allow continuous movement of the movable window 18 as the movable window 18 moves between the closed and open positions.

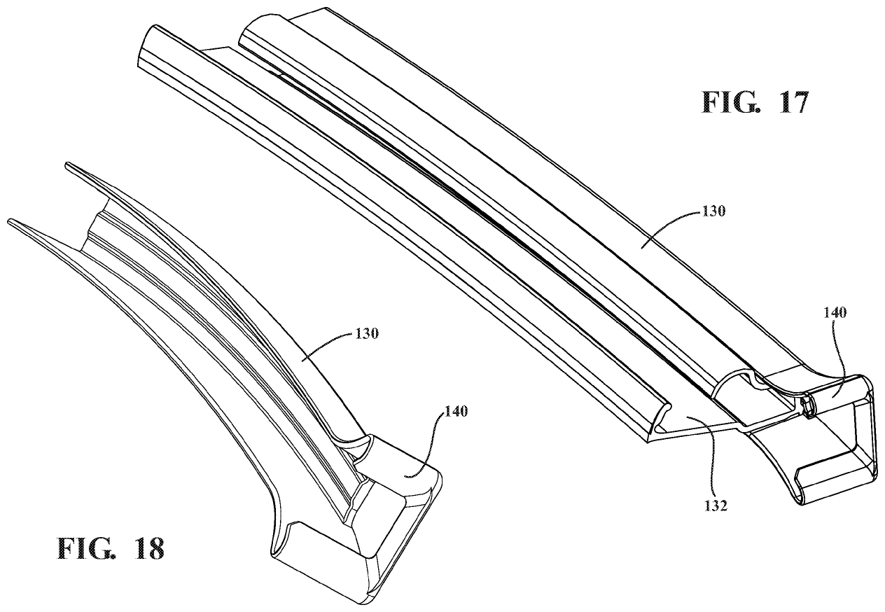

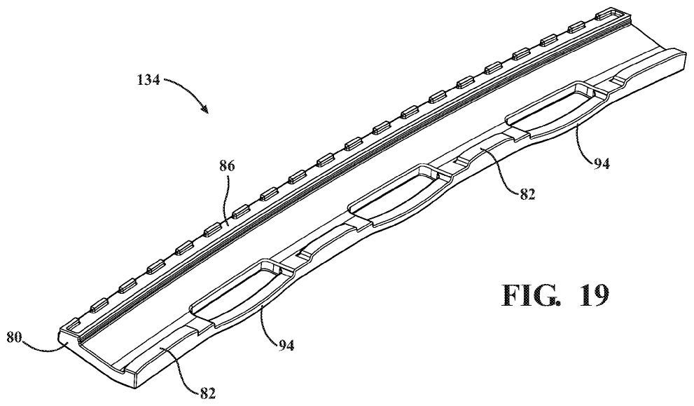

Referring specifically to FIGS. 8-19, the flush glass system 10 includes the seal assembly 74 including the seal 76 and the guide structure 19. The guide structure 19 is slidably coupled to and movable relative to the seal 76. As mentioned above, movable window and glass pane 17 have the outer surface 17A, the inner surface 17B, and edges 17C with the guide structure 19 coupled to the inner surface 17B of the glass pane 17. The guide structure 19 is movable with the glass pane 17 as the window 18 moves between the open and closed positions. As discussed elsewhere, the guide structure 19 has limiting portions and a contacting portion such that at least three sides or surfaces engage the seal to support the glass pane 17 of the movable window 18 throughout movement of the movable window 18. With the three sides of engagement, the guide structure and movable window is supported for transverse movement relative to the vehicle as well as longitudinal movement relative to the vehicle.

In some configurations, the guide structure 19 includes a body portion 78 (which may be referred to herein as a connecting body), a connecting portion 80, a first limiting portion 82 (which may be referred to herein as a first raised structure or a first raised portion), a second limiting portion 84 (which may be referred to herein as a second raised structure or a second raised portion), and a contacting portion 86 (which may be referred to herein as a contact foot). It will be appreciated that the terms may be used interchangeably unless otherwise stated. In some configurations, the connecting portion 80 of the guide structure 19 is coupled to the inner surface 17B of the glass pane 17 to support the glass pane 17 as the movable window 18 moves between the closed and open positions.

The seal 76 includes a plurality of sealing portions, including an exterior sealing lip 72. The exterior sealing lip 72 is disposed between an edge of the window and the trim panel to occupy the gap formed between the window and the trim panel. This feature of occupying the gap is addressed further below. Also, in certain embodiments, the seal 76 may include the exterior sealing lip 72, a second sealing portion 100, a third sealing portion 102, and a fourth sealing portion 104. The particular configuration of the seal 76 and the portions are discussed in greater detail below. It is contemplated that the seal 76 may include any number of sealing portions. The plurality of scaling portions are formed of a polymeric material, such as the one or more types of EPDM (Ethylene Propylene Diene Monomer) rubber and/or TPV (Thermoplastic Vulcanized) rubber. The configurations of the seal 76 including the plurality of sealing portions will be discussed in greater detail below.

The first channel 22 of the trim panel 20 accommodates the seal 76, which can be appropriately secured therein, such as by an adhesive or mechanical interference. Said differently, the seal 76 is arranged within the first channel 22 of the trim panel 20 and secured to the trim panel by way of an interference fit, a tension fit, a press fit, a slip fit, or any other appropriate securing method and/or any combination of securing methods.

Turning to FIGS. 16-19, an opposing side from the trim panel of the flush glass system 10 is shown. A trim member 130 is mounted to the frame of the vehicle in a similar manner as the trim panel. A trim member seal 132 is disposed within the trim member 130 is a similar manner as the seal disposed within the trim panel. An opposing edge of the window engages an exterior sealing lip 72 of the trim member seal 132 in a similar manner. Also, a second guide structure 134 is mounted to the window approximate the opposing edge with the second guide structure 134 engaging the trim member seal 132 disposed within the trim member 130 to guide the opposing edge of the movable window. The second guide structure 134 has at least one first limiting portion 82 and at least one first elastic member 94. As shown, there are a series of first limiting portions 82 and a series of first elastic members 94. The second guide structure 134 also has a connecting portion 80 and a contacting portion 86. These features are similar to those discussed above and below, but the second guide structure 134 is configured differently than the guide structure 19 in that it retains the window against movement transverse to the guide structure but does not restrict movement of the window along the longitudinal axis of the vehicle. That restricted movement is controlled by the guide structure 19 disposed within the trim panel 20. The guide structure 19 and second guide structure 134 work together to retain the window 18 within the door. Also included is a second below belt member 136 adjacent the trim member. A second below belt seal 138 is disposed within the second below belt member 136 in a complementary manner as the below belt seal in the below belt member. Both the trim member and the second below belt member include corresponding flared portions 140, 142 in a similar manner as the trim panel and below belt member.

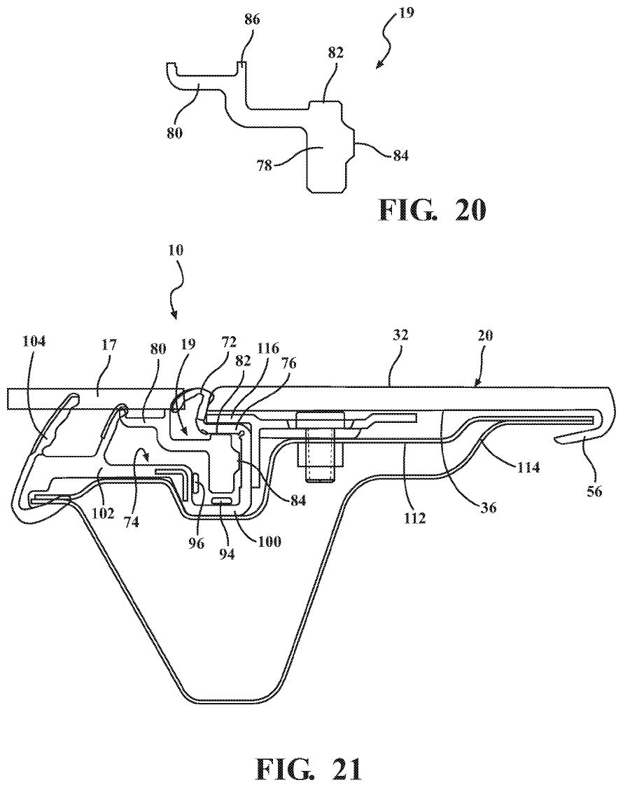

Referring specifically now to FIGS. 20-24, according to another embodiment, the flush glass system 10 (which may be referred herein as a flat door system) includes a sliding block structure 19, a glass piece 17 and a trim panel structure. The sliding block structure 19 includes a connecting structure, a first raised structure 82 and a second raised structure 84. The connecting structure includes a connecting body 78 and a connecting portion 80. The connecting body 78 and the connecting portion 80 are fixedly connected with each other. The connecting body 78 has a first wall surface and a second wall surface. The first wall surface and the second wall surface are arranged to intersect with each other. The first raised structure 82 is arranged to protrude along the direction perpendicular to the first wall surface, and the second protruding portion 84 is arranged to protrude along the direction perpendicular to the second wall surface. The glass piece 17 is connected with the connecting portion 80. The trim panel structure includes a trim panel 20 slidably connected to the sliding block structure 19. The connecting body 78 extends along the sliding direction of the connecting body 78. A first guiding portion and a second guiding portion are arranged on the trim panel 20. The first guiding portion is slidably connected to the first raised structure 82, and the second guiding portion is slidably connected to the second raised structure 84.

In the flat door system provided in this configuration, the connecting portion 80 is connected with the glass piece 17, and the connecting body 78 is fixedly connected with the connecting portion 80, in order to make the glass piece 17 and the sliding block structure 19 as a unit, so that the sliding block structure 19 and the glass piece 17 can move together under the action of external driving force. By the intersecting first wall surface and second wall surface arranged on the connecting body 78, the first wall surface and the second wall surface are the side surfaces of the connecting body 78 in the direction of the movement along the glass piece 17. The first wall surface is limited by and cooperates with the first guiding portion, and the second wall surface is limited by and cooperates with the second guiding portion, so that the first raised structure 82 on the first wall surface and the second raised structure 84 on the second wall surface form two limiting regions which intersect with each other. Therefore, the trim panel structure can limit and guide the sliding block structure 19, thereby improving the stability of the glass piece 17. When the forces such as external wind resistance are applied to the glass piece 17, the glass piece 17 has a good resistance to external effects.

In the flat door system provided in this configuration, the sliding block structure 19 further comprises a first clastic part 94. The first clastic part 94 is disposed on the opposite side of the connecting body 78 away from the first raised structure 82 in the protruding direction of the first raised structure 82. When the connecting body 78 is driven by an external force to move away from the trim panel 20, the first elastic part 94 has a first elastic force which drives the connecting body 78 moving towards the trim panel 20. The acting direction of the first elastic force is parallel to the protruding direction of the first raised structure 82. The first elastic part 94 is suitable for slidable connection with the trim panel structure.

In the flat door system provided in this configuration, the movement of the connecting body 78 is limited by the first elastic part 94 and the first raised structure 82. The first elastic force provided by the first elastic part 94 is in the direction of driving the connecting body 78 towards the trim panel 20, thereby promoting the tight connection between the connecting body 78 and the trim panel 20, increasing the contact force between the first raised structure 82 and the first guiding portion, promoting the stability of the sliding block structure 19 during movement, and ensuring the sealing performance between the seal 76 and the sliding block structure 19. The acting direction of the first elastic force is parallel to the protruding direction of the first raised structure 82. When the limiting plane provided by the first raised structure 82 is a flat plane, the acting direction of the first elastic force is perpendicular to such plane, so as to facilitate the positioning of the first raised structure 82 in the first guiding portion, thereby improving the stability of the sliding block structure 19 and the glass piece 17 when moving together.

In the flat door system provided in this configuration, the sliding block structure 19 further comprises a second elastic part 96. The second elastic part 96 is disposed on the opposite side of the connecting body 78 away from the second raised structure 84 in the protruding direction of the second raised structure 84. When the connecting body 78 is driven by an external force to move away from the trim panel 20, the second elastic part 96 has a second elastic force which drives the connecting body 78 moving towards the trim panel 20. The acting direction of the second elastic force is parallel to the protruding direction of the second raised structure 84. The second elastic part 96 is suitable for slidable connection with the trim panel structure.

In the sliding block structure 19 of this structure, the movement of the connecting body 78 is limited by the second elastic part 96 and the second raised structure 84. The first elastic force provided by the first elastic part 94 functions for driving the connecting body 78 towards the trim panel 20, thereby promoting the tight connection between the connecting body 78 and the trim panel 20, increasing the contact force between the first raised structure 82 and the first guiding portion, promoting the stability of the sliding block structure 19 during movement, and ensuring the sealing performance between the seal 76 and the sliding block structure 19, so as to improve the stability of the sliding block structure 19 and the glass piece 17 when moving together.

In the flat door system provided by this configuration, the first elastic part 94 is an arc-shaped structure. A first vacant cavity is formed between the first elastic part 94 and the connecting body 78.

In the flat door system provided in this configuration, the first elastic part 94 is an arc-shaped structure. The arc-shaped structure generates a first elastic force to act on the connecting body 78 to approach the trim panel 20. After the sliding block structure 19 is installed within the trim panel structure, the first elastic part 94 can generate a preloading force on the connecting body 78, thereby increasing the contact surface between the sliding block structure 19 and the trim panel 20, and promoting the limiting ability of the first guiding portion to limit the first raised structure 82. The space for the deformation such as the contraction and expansion of the arc-shaped structure is provided by the first vacant cavity. When the external force is transmitted to the sliding block structure 19 via the glass piece 17, the expansion and contraction of the arc-shaped structure is used to compensate a part of the transmitted force, to promote the stability of the glass piece 17.

In the flat door system provided in this configuration, the connecting portion 80 is provided with at least one recess, and the recess is suitable for containing an external adhesive. The concave space area of the recess is used to accommodate the external adhesive, so that the glass piece 17 and the sliding block structure 19 are fixedly connected by the external adhesive, thus the glass piece 17 and the sliding block structure 19 move together under the driving of external force, ensuring the connection strength between the glass piece 17 and the sliding block structure 19.

In the flat door system provided by this configuration, at least one contact foot 86 is formed on the connecting portion 80, and the contact foot 86 is suitable for fixedly connecting the glass piece 17. A plurality of the contact feet 86 and the connecting portion 80 collectively form the recess. The recess is formed by a plurality of contact feet 86 and the connecting portion 80 together. The contact feet 86 are protruding to the outside of the connecting portion 80. After the glass piece 17 is fixed to the sliding block structure 19, the protruding ends of the contact feet 86 abut against the glass piece 17, so that the wind resistance force of the glass piece 17 is transmitted to the connecting portion 80 via the contact feet 86, then transmitted to the connecting body 78 via the connecting portion 80, and then transmitted to the first raised structure 82 and the second raised structure 84 via the connecting body 78.

In the flat door system provided in this configuration, the outer wall surface of the glass piece 17 and the outer wall surface of the trim panel 20 are coplanar, so that the connection between the glass piece 17 and the trim panel 20 forms a zero-step structure, thereby promoting the smooth transition between the whole glass piece 17 and the trim panel 20, reducing the wind resistance coefficient at the connection between the glass piece 17 and the trim panel 20, and improving the stability of the glass piece 17.

In the flat door system provided in this configuration, the trim panel structure further includes a first connecting plate 112, a second connecting plate 114, and a bracket 116. The first connecting plate 112 and the second connecting plate 114 are arranged on the same side of the trim panel 20. The first connecting plate 112 and the second connecting plate 114 are fixedly connected to the trim panel 20. The bracket 116 is arranged between the trim panel 20 and the first connecting plate 112. The bracket 116 is connected on the first connecting plate 112. The bracket 116 includes a mounting plate 118 and a limiting plate 120. The mounting plate 118 is arranged between the trim panel 20 and the first connecting plate 112. The mounting plate 118 is detachably connected to the first connecting plate 112. The limiting plate 120 is fixedly connected to the mounting plate 118. The limiting plate 120 bends to form the first guiding portion and the second guiding portion.

In the flat door system provided in this configuration, the bracket 116 is installed by the cooperation of the first connecting plate 112 and the trim panel 20. The second connecting plate 114 forms a support for the first connecting plate 112, so that the first connecting plate 112 and the bracket 116 is tightly connected. The mounting plate 118 and the first connecting plate 112 are detachably connected, which effectively improves the convenience of installation and disassembly between the bracket 116 and the first connecting plate 112. By bending the limiting plate 120 to form the first guiding portion and the second guiding portion, it enables the first raised structure 82 and the second raised structure 84 to perform position-limiting cooperation with the limit plate 120 through the seal assembly 74, so that the sliding block structure 19 and the glass piece 17 slide along the extending direction of the limit plate 120. The limiting plate 120 determines the movement displacement of the sliding block structure 19 to ensure the positioning of the sliding block structure 19 and the glass piece 17 on the trim panel structure.

As an alternative implementation of this configuration, the limit plate 120 comprises a first limiting wall and a second limiting wall that are arranged to intersect with each other. The first limiting wall is suitable for sliding with respect to the first raised structure 82. The second limiting wall is suitable for sliding with respect to the second raised structure 84. The structures of the first limiting wall and the second limiting wall can be specifically configured according to the limiting regions of the first raised structure 82 and the second raised structure 84. The first limiting wall and the second limiting wall can be arranged to be flat planes. The limiting regions on the first raised structure 82 and the second raised structure 84 are flat planes. The limiting surface of the first raised structure 82 is in surface contact with the first limiting wall, and the limiting surface of the second raised structure 84 is in surface contact with the second limiting wall.

As an alternative implementation of this configuration, the mounting plate 118 is connected to the first connecting plate 112 by a connecting piece 122. The connecting piece 122 is a threaded fastener. The connecting piece 122 penetrates the mounting plate 118 and is connected to the first connecting plate 112. The assembly between the bracket 116 and the first connecting plate 112 is facilitated by the connecting piece 122.

The flat door system provided in this configuration further includes a seal 76. The seal 76 is integrally provided. The seal 76 is suitable for sliding in contact with and abutting against the first raised structure 82 and the second raised structure 84. The trim panel structure and the sliding block structure 19 are arranged apart. The seal 76 is arranged between the trim panel structure and the sliding block structure 19. The trim panel structure and the glass piece 17 are arranged apart, so that the seal 76 is disposed between the trim panel structure and the glass piece 17. The seal 76 is fixedly connected to the trim panel structure, and the seal 76 is slidably connected to the glass piece 17.

In the flat door system provided in this configuration, by arranging the seal 76 between the trim panel structure and the glass piece 17, the space gap between the trim panel structure and the glass piece 17 is eliminated to prevent external fluids such as airflow and rainwater from entering in the flat door system. Thus, it ensures the airtightness of the flat door system. By arranging the seal 76 between the trim panel structure and the sliding block structure 19, the gap space between the trim panel structure and the sliding block structure 19 is filled to ensure the sliding and abutting sealing between the first guiding portion and the first limiting portion and between the second guiding portion and the second limiting portion. thereby improving the connection strength of the sliding block structure 19, the seal 76 and the trim panel structure, and promoting the stability of the glass piece 17 when moving. The vibration of the glass piece 17 under the condition such as wind resistance can be absorbed and compensated by the seal 76, thereby promoting the stability of the glass piece 17 after installation. The seal 76 is an integrated part to ensure the sealing ability of the whole flat door system, avoiding the gap between the sealing strips after the installation, and avoiding the infiltration of external fluids such as airflow and rainwater.

In the flat door system provided in this configuration, the seal 76 includes a first sealing portion 74, a second sealing portion 100, and a third sealing portion 102 connected in sequence. The first sealing portion 74 is provided between the trim panel 20 and the glass piece 17. The first sealing portion 74 is fixedly connected to the trim panel 20. The first sealing portion 74 is slidably connected to the glass piece 17. The second sealing portion 100 is fixedly connected to the inner walls of the first guiding portion and the second guiding portion. The second sealing portion 100 is fixedly connected to the limiting plate 120. The second sealing portion 100 is fixedly connected to the first connecting plate 112. The second sealing portion 100 is slidably connected to the sliding block structure 19. The third sealing portion 102 is arranged between the glass piece 17 and the first connecting plate 112. The third sealing portion 102 is slidably connected to the glass piece 17. The third sealing portion 102 is fixedly connected to the first connecting plate 112.

In the flat door system provided in this configuration, the first sealing portion 74 is slidably connected to the glass piece 17. The first sealing portion 74 is fixedly connected to the trim panel 20. The first sealing portion 74 fills and seals the space between the trim panel 20 and the glass piece 17, such that the impurities such as rainwater and airflow from the outside are prevented from entering the flat door system. The second sealing portion 100 slides against the first raised structure 82 to form a sealing area between the first guiding portion and the first raised structure 82. The third sealing portion 102 slides against the second raised structure 84 to form a sealing area between the second guiding portion and the second raised structure 84. The third sealing portion 102 slides against the second raised structure 84 to form a sealing area between the second guiding portion and the second raised structure 84. The fourth sealing portion slides against the glass piece 17, so that the glass piece 17 is limited by the fourth scaling portion, which is beneficial to improve the stability of the glass piece 17.

The flat door system provided in this configuration further includes a support member 110. The support member 110 is arranged in the seal 76 between the second sealing portion 100 and the third sealing portion 102. The support member is suitable for cooperating with the sliding movement of the first elastic part 94. The strength of the seal 76 is enhanced by the support member 110, and the first elastic part 94 is supported by the support member 110, thus it is beneficial to the stability of the sliding block structure 19 and the glass piece 17 when moving together. The shapes of the support member 110 and the first connecting plate 112 conform to each other.

In the flat door system provided in this configuration, the seal 76 further includes at least one abutting portion 104. The abutting portion 104 is fixedly connected to the third sealing portion 102. The abutting portion 104 is slidably connected to the glass piece 17. The glass piece 17 is limited by the abutting portion 104, thereby promoting the sliding movement of the glass piece 17 along the extending direction of the limiting plate 120, which is beneficial to improve the movement accuracy of the glass piece 17.

In the flat door system provided in this configuration, the seal 76 further includes a hooking portion 106. The hooking portion 106 is fixedly connected to the third sealing portion 102. The hooking portion 106 catches the first connecting plate 112 and the first connecting plate 112. The first connecting plate 112 is connected with the second connecting plate 114 and the seal 76 by the hooking portion 106, so that the first connecting plate 112 and the second connecting plate 114 form a support for the seal 76 and improve the connection strength between the seal 76 and the trim panel structure, thereby making the seal 76 more suitable for the sliding state between the sliding block structure 19 and the trim panel structure. It is to be appreciated that the hooking portion 106 is optional.

In the flat door system provided in this configuration, a bending portion or hook 56 is provided on the end of the trim panel 20 away from the glass piece 17. The curved end of the bending portion 56 is extended towards the glass piece 17. One side of the bending portion 56 abuts against the second connecting plate 114. An end of the second connecting plate 114 is connected at a location between the bending portion 56 and the first connecting plate 112. The ends of the first connecting plate 112 and the second connecting plate 114 are fixed on the inner side of the trim panel 20 by the bending portion 56 to ensure the contact area between the trim panel 20 and the first connecting plate 112 and between the first connecting plate 112 and the second connecting plate 114, which improves the connection strength inside the trim panel structure, and forms an effective supporting for the sliding block structure 19 on the inner side of the trim panel 20, thereby improving the stability of the sliding block structure 19 and the glass piece 17 when moving together.

In the flat door system provided in this configuration, the first raised structure 82 includes at least one first limiting portion; and the second raised structure 84 includes at least one second limiting portion.

In the flat door system provided in this configuration, the first limiting portion cooperates with the first guiding portion and the second limiting portion cooperates with the second guiding portion to limit the sliding block structure 19, so that the sliding block structure 19 and the glass piece 17 move together in the limited direction, promoting the movement accuracy of the glass piece 17. The first raised structure 82, the second raised structure 84, and the trim panel structure contact with the limit regions for limiting, in particular by the shape conforming of the first guiding portion and the second guiding portion formed by the trim panel structure, in order to facilitate the limiting and guiding between the sliding block structure 19 and the trim panel structure.

As an alternative implementation of this configuration, the first limiting portion can be configured as a protrusion formed on the first wall surface. There may be two or more protrusions spaced apart on the first wall surface. The protrusions slidably cooperate with the first guiding portion to provide a limited direction for the sliding block structure 19.

As an alternative implementation of this configuration, the second limiting portion may be configured as a protrusion formed on the second wall surface. There may be two or more protrusions spaced apart on the second wall surface. The protrusions slidably cooperate with the second guiding portion to provide another limited direction for the sliding block structure 19.

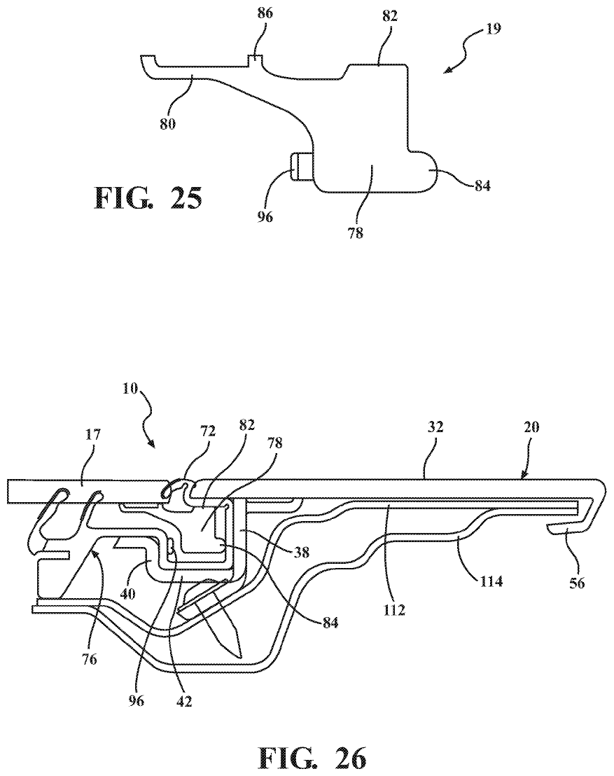

Turning now to FIGS. 25-29, according to yet another embodiment, the flush glass system (which may be referred herein as a flat door system) includes a sliding block structure 19, a glass piece 17 and a trim panel structure. The sliding block structure 19 includes a connecting structure and limiting structure. The connecting structure includes a connecting body 78 and a connecting portion 80. The connecting body 78 is fixedly connected with the connecting portion 80. The connecting body 78 has a first wall surface, a second wall surface and a third wall surface. The first wall surface and the second wall surface are arranged to intersect with each other. The first wall surface is opposite to the third wall surface. The second wall surface is arranged between the first wall surface and the third wall surface. The limiting structure includes a first raised portion 82 and a second raised portion 84. The first raised portion 82 is provided on the first wall surface, and the second raised portion 84 is provided on the end of the second wall surface which is near the third wall surface. The glass piece 17 is connected with the connecting portion 80. The trim panel structure is provided with a first guiding portion and a second guiding portion. The first guiding portion is slidably connected with the first raised portion 82, and the second guiding portion is slidably connected with the second raised portion 84.

In the flat door system provided in this configuration, the glass piece 17 is connected with the sliding block structure 19 by the connecting structure, so that the sliding block structure 19 and the glass piece 17 can move together under the action of external driving force. The first guiding portion cooperates with the first limiting portion to limit the position, and the second guiding portion cooperates with the second limiting portion to limit the position, thereby forming two limit regions for limiting the sliding block structure 19, so that the trim panel structure can limit and guide the movement of the sliding block structure 19 and the glass piece 17, thereby improving the movement accuracy of the glass piece 17 in the flat door system. By arranging the first raised portion 82 on the first wall surface of the connecting body 78, and arranging the second raised portion 84 on the second wall surface of the connecting body 78, the second raised portion 84 is located at the end of the second wall surface close to the third wall surface, so that the limit regions determined by the first raised portion 82 and the second raised portion 84 have a reasonable spacing. Thus, there are sufficient contact space between the first raised portion 82 and the first guiding portion, and between the first raised portion 82 and the second guiding portion, so that the sliding block structure 19 and the glass piece 17 can move according to the sliding and guided space provided by the trim panel structure, so as to improve the stability of the glass piece 17.

As an alternative implementation of this configuration, the first limiting portion can be configured as a protrusion formed on the first wall surface. There may be two or more protrusions spaced apart on the first wall surface. The protrusions slidably cooperate with the first guiding portion to provide a limited direction for the sliding block structure 19.

As an alternative implementation of this configuration, the second limiting portion can be configured as a protrusion formed on the second wall surface. There may be two or more protrusions spaced apart on the second wall surface. The protrusions slidably cooperate with the second guiding portion to provide another limited direction for the sliding block structure 19.

In the flat door system provided in this configuration, the limiting structure further includes an elastic part 96. The elastic part 96 is disposed on the opposite side of the connecting body 78 away from the second raised portion 84 in the protruding direction of the second raised portion 84. When the connecting body 78 is driven by an external force to move away from the trim panel 20, the elastic part 96 has an elastic force which drives the connecting body 78 moving towards the trim panel 20. The acting direction of the elastic force is parallel to the protruding direction of the second raised portion 84. The elastic part 96 is suitable for slidable connection with the trim panel 20 structure

In the flat door system provided in this configuration, the movement of the connecting body 78 is limited by the cooperation of the elastic part 96 and the second raised portion 84. The elastic force provided by the elastic part 96 is in the direction of driving the connecting body 78 towards the trim panel 41, thereby promoting the tight connection between the connecting body 78 and the trim panel 41. The contact force between the first raised portion 82 and the first guiding portion for limiting the position is increased, thereby promoting the stability of the sliding block structure 19 during movement, and facilitating reducing the spacing between the sliding block structure 19, the seal 5 and the trim panel structure. It ensures the sealing performance between the seal 76 and the sliding block structure 19, and improves the sealing effect of the seal 76. The elastic force of the elastic part 96 acts in the direction which is parallel to the protruding direction of the second raised portion 84. When the limiting surface provided by the first raised structure is a flat plane, the acting direction of the first elastic force is perpendicular to such plane. The movement of the sliding block structure 19 in the extending directions of this plane is limited by both the second raised portion 84 and the elastic part 96, so as to improve the guiding and positioning between the sliding block structure 19 and the trim panel structure, thereby improving the stability of the sliding block structure 19 and the glass piece 17 when they move together.

In the flat door system provided in this configuration, the elastic part 96 is an arc-shaped structure. A vacant space is provided between the arc-shaped structure and the connecting body 78. The vacant space is suitable for accommodating the deformation such as the expansion and contraction of the arc-shaped structure. An elastic force is generated by the arc-shaped structure to make the connecting body 78 moving towards the trim panel 41. After the sliding block structure 19 is installed in the trim panel structure, the elastic part 96 generates a pre-tightening force on the connecting body 78 to promote the tight connection between the sliding structure and the trim panel structure. After the arc-shaped structure is deformed, the contact area between the elastic part 96 and the trim panel structure increases. By increasing the contact surface between the sliding block structure 19 and the trim panel 41, the ability of the first guiding portion for limiting the position of the first raised structure is improved. The first vacant cavity provides the space for the deformation of the are-shaped structure in advance. When the external force is transmitted to the sliding block structure 19 via the glass piece 17, the expansion and contraction of the arc-shaped structure is used to compensate a part of the transmitted force, to promote the stability of the glass piece 17.

In the flat door system provided by this configuration, the connecting body includes a vacant part 111. The elastic part 96 is configured on the vacant part 111. A vacant space is formed at the vacant part 111 to not interfere with the deformation of the elastic part 96. The vacant part 111 is a concave structure. Both ends of the elastic part 96 are formed on the vacant part 111.

In the flat door system provided in this configuration, the connecting structure is inclined on the wall surface of the glass piece 17. The end of the connecting body 78 in the connecting structure which is away from the glass piece 17 extends to the outer edge of the glass piece 17, so that the trim panel structure constitutes a support for the middle area of the glass piece 17. The limiting and supporting ability of the trim panel structure to the glass piece 17 is improved, which is beneficial to promote the transmission and distribution of external force, and promote the distribution of the force to the first limiting portion and the second limiting portion. The force is further resisted and absorbed by the trim panel structure, so as to achieve the purpose of improving the stability of the glass piece 17.

In the flat door system provided in this configuration, the connecting portion 80 is provided with at least one recess. The recess is suitable for containing an external adhesive. The glass piece 17 and the sliding block structure 19 are fixedly connected by an external adhesive to ensure the connection strength between the glass piece 17 and the sliding block structure 19, so that when the external driving force acts on the glass piece 17 or the sliding block structure 19, the glass piece 17 and the sliding block structure 19s move together within the space provided by the trim panel structure.

In the flat door system provided in this configuration, at least one contact foot 86 is formed on the connecting portion 80. The contact foot 86 is suitable for connecting the glass piece 17. A plurality of contact feet 86 and the connecting portion 80 collectively form the recess. The recess is formed by a plurality of contact feet 86 and the connecting portion 80 together. The contact feet 86 are protruding to the outside of the connecting portion 80. After the glass piece 17 is fixed to the sliding block structure 19, the protruding ends of the contact feet 86 abut against the glass piece 17, so that the wind resistance force of the glass piece 17 is transmitted to the connecting portion 80 via the contact feet 86, then transmitted to the trim panel structure via the first limiting portion, the second limiting portion and the elastic part 96.

In the flat door system provided in this configuration, the trim panel structure further includes a guide bracket. The guide bracket is fixedly connected to the trim panel 20. The guide bracket includes a first connecting plate or branch 38, a second connecting plate or base 42, and a third connecting plate or branch 40. The first connecting plate 38 is fixedly connected to the trim panel 20. The first connecting plate 38 is suitable for sliding connection with the second raised portion 84. The second connecting plate 42 is fixedly connected on the same side of the trim panel 20 as the first connecting plate 38. The third connecting plate 40 is fixedly connected on the same side of the first connecting plate 38 as the second connecting plate 42. The third connecting plate 40 is suitable for sliding connection with the elastic part 94. The trim panel 20, the first connecting plate 38, the second connecting plate 42, and the third connecting plate 40 collectively form the first guiding portion and the second guiding portion.

In the flat door system provided in this configuration, the first guiding portion and the second guiding portion are formed by the cooperation of the guide bracket and the trim panel 20. The guide bracket slidably cooperates with the first raised portion 82 and the second raised portion 84, so that the guide bracket and the trim panel 20 constitute the limiting and supporting for the sliding block structure 19. Thus the sliding block structure 19 and the glass piece 17 slide along the extension direction of the limiting plate. The limiting plate determines the movement displacement of the sliding block structure 19 to ensure the positioning of the sliding block structure 19 and glass piece 17 on the trim panel 20 structure.

The flat door system provided in this configuration further includes a seal 76. The seal 76 is integrally provided. The seal 76 is suitable for slidably abutting against the first raised portion 82 and the second raised portion 84. The trim panel 20 structure and the sliding block structure 19 are spaced apart. The seal 76 is arranged between the trim panel 20 structure and the sliding block structure 19. The trim panel 20 structure and the glass piece 17 are spaced apart. The seal 76 is arranged between the trim panel 20 structure and the glass piece 17. The seal 76 is fixedly connected on the trim panel 20 structure. The seal 76 is slidably connected to the glass piece 17.

In the flat door system provided in this configuration, the space gap between the trim panel 20 structure and the glass piece 17 is eliminated by the seal 76, such that external fluids such as airflow and rainwater are prevented from entering the flat door system, and the airtightness of the flat door system is ensured. The seal 76 fills the gap space between the trim panel 20 structure and the sliding block structure 19, thereby promoting the sliding and abutting seal between the first guiding portion and the first limiting portion and the sliding and abutting seal between the second guiding portion and the second limiting portion, thereby improving the connection strength of the sliding block structure 19, the seal 76 and the trim panel 20 structure, and promoting the stability of the glass piece 17 in the moving state. The vibration of the glass piece 17 under the conditions such as wind resistance can be absorbed and compensated by the seal 76, thereby promoting the stability of the glass piece 17 after installation. The seal 76 is an integrated part to ensure the sealing ability of the whole flat door system, avoiding the gap between the sealing strips after the installation, and avoiding the infiltration of external fluids such as airflow and rainwater.

In the flat door system provided in this configuration, the trim panel 20 structure includes a trim panel 20 slidably connected to the sliding block structure 19. The outer wall surface of the glass piece 17 is coplanar with the outer wall surface of the trim panel 20. By arranging the glass piece 17 and the trim panel 20 coplanar, the connection between the glass piece 17 and the trim panel 20 forms a zero-step structure, thereby promoting a smooth transition between the overall glass piece 17 and the trim panel 20, which is beneficial to reducing the wind resistance coefficient of the flat door system, thereby enhancing the stability of the glass piece 17.

In the flat door system provided in this configuration, the first connecting plate 38 and the third connecting plate 40 are arranged in parallel and spaced apart, and the first connecting plate 38 and the second connecting plate 42 are arranged to be perpendicular to each other, so that the first guiding portion of the trim panel 20 structure is perpendicular to the second guiding portion. Thus the first limiting portion is perpendicular to the second limiting portion, so that the trim panel 20 structure limits the sliding block structure 19 in two mutually perpendicular directions. The external force is distributed and transmitted by the first limiting portion and the second limiting portion which are perpendicular to each other.

In the flat door system provided in this configuration, the seal 76 includes a first sealing portion 72, a second sealing portion 100, and a third sealing portion 102 which are connected in sequence. The first sealing portion 72 is arranged between the trim panel 20 and the glass piece 17. The first sealing portion 72 is fixedly connected to the trim panel 20. The first sealing portion 72 is slidably connected to the glass piece 17. The second sealing portion 100 is fixedly connected to the inner wall of the guiding portion. The second sealing portion 100 is slidably connected with the sliding block structure 19. The third sealing portion 102 is arranged between the glass piece 17 and the trim panel 20 structure. The third sealing portion 102 is slidably connected to the glass piece 17, and the third sealing portion 102 is fixedly connected to the trim panel 20 structure.

In the flat door system provided in this configuration, the first sealing portion 72 fills and seals the gap space between the trim panel 20 and the glass piece 17 to prevent external impurities such as rainwater and airflow from entering the flat door system. The first sealing portion 72 is slidably connected to the glass piece 17. The first sealing portion 72 is fixedly connected to the trim panel 20. The first sealing portion 72 cooperates with the sliding trim panel 20 structure to limit and guide the sliding block structure 19. The second sealing portion 100 is arranged on the inner walls of the first guiding portion and the second guiding portion. The second sealing portion 100 slidably abuts against the first limiting portion and the second limiting portion, forming a sealing area in the sliding space between the trim panel 20 structure and the sliding structure. The third sealing portion 102 slidably abuts against the glass piece 17, so that the position of the glass piece 17 is limited by the third sealing portion 102, which is beneficial to improve the stability of the glass piece 17.

In the flat door system provided in this configuration, the seal 76 further includes at least one abutting portion 104. The abutting portion 104 is fixedly connected to the trim panel 20 structure. The abutting portion 104 is slidably connected to the glass piece 17. The position of the glass piece 17 is limited by the abutting portion 104, thereby promoting the sliding of the glass piece 17 along the extending direction of the guide bracket, which is beneficial to improve the movement accuracy of the glass piece 17. At the same time, it helps to improve the connection strength between the seal 76 and the trim panel 20 structure, thereby the seal 76 more suitable for the sliding state between the sliding block structure 19 and the trim panel 20 structure.

In the flat door system provided in this configuration, the trim panel 20 structure further includes a first mounting plate 112 and a second mounting plate 114. The first mounting plate 112 is detachably connected to the guide bracket. The first mounting plate 112 is fixedly connected to the trim panel 20. The first mounting plate 112 is suitable for abutting against and connecting the seal 76. The second mounting plate 114 is arranged between the trim panel 20 and the second mounting plate 114. The first mounting plate 114 is fixedly connected to the second mounting plate 114. The seal 76 is supported by the first mounting plate 112, so that the seal 76 is fastened between the first mounting plate 112 and the glass piece 17. The ends of the first mounting plate 112 and the second mounting plate 114 are bonded in surface contact with each other. The connection strength of the trim panel 20 is ensured by the contact between the two, thereby promoting the stability of the sliding block structure 19 and the glass piece 17 when they move together.

In the flat door system provided in this configuration, in the flat door system provided in this configuration, the trim panel 20 structure further includes a connecting bracket 108. The connecting bracket 108 is connected between the trim panel 20 and the first connecting plate 38. The connecting bracket 108 is disposed on the same side of the seal 76 as the first connecting plate 38. The connecting bracket 108 is fixedly connected to the trim panel 20. The connecting bracket 108 is fixedly connected and perpendicular to the first connecting plate 38. The connecting bracket 108 forms an auxiliary support for the first connecting plate 38 and at the same time improves the connection strength between the guide bracket and the trim panel 20.

In the flat door system provided in this configuration, the guide bracket is detachably connected to the first mounting plate 112 by the locking member 124, so as to ensure the connection strength of the guide bracket and the first mounting plate 112. When the external force is applied to the glass piece 17, the force is transmitted to the first mounting plate 112 and the second mounting plate 114 via the guide bracket which absorbs and resists the external force.

In the flat door system provided in this configuration, a bending portion or hook 56 is provided on the end of the trim panel 20 away from the glass piece 17. The curved end of the bending portion 56 extends towards the glass piece 17. One side of the bending portion 56 abuts against the second mounting plate 114. The end of the second mounting plate 114 is connected and disposed between the bending portion 56 and the first mounting plate 112.

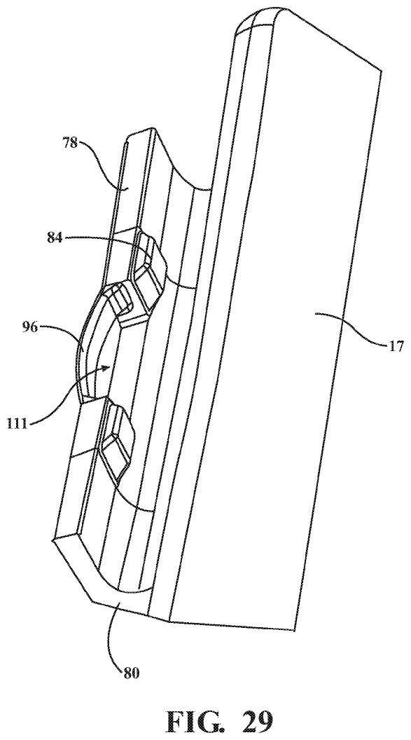

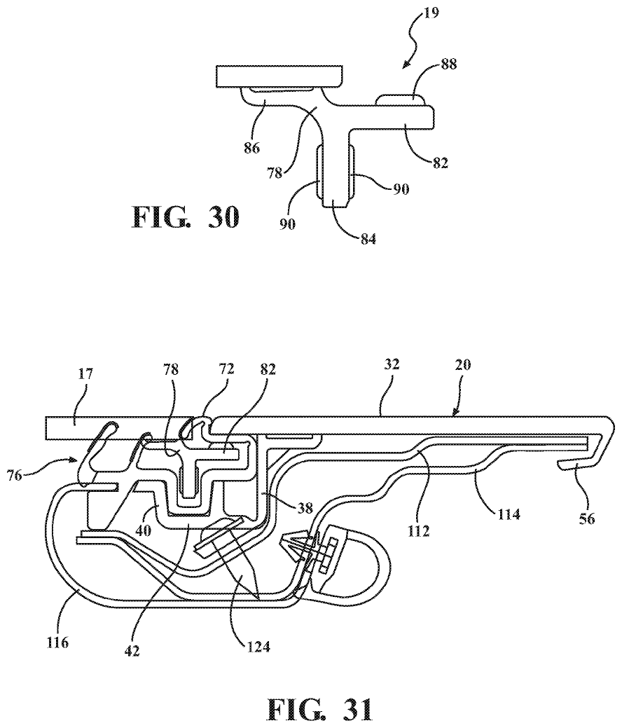

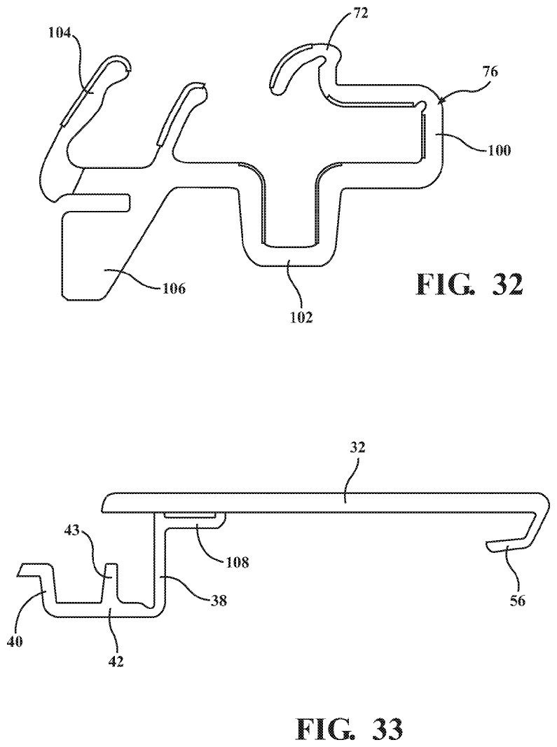

Referring now to FIGS. 30-33, according to a further alternative embodiment, the flush glass system (which may be referred herein as a flat door system) includes the flat door system includes a sliding block structure 19, a glass piece 17, and a trim panel structure. It will be appreciated that the trim panel structure, in some configurations, may be the trim panel 20 or any component of the trim panel 20 such as the exterior member 32. The sliding block structure 19 includes a body portion 78 and a first limiting portion 82 and a second limiting portion 84 which are fixedly connected to the body portion 78. The first limiting portion 82 is arranged at a first angle relative to the second limiting portion 84. The glass piece 17 is fixedly connected with the body portion 78. The trim panel structure is provided with a first guiding portion and a second guiding portion. The first guiding portion is slidably connected to the first limiting portion 82, and the second guiding portion is slidably connected to the second limiting portion 84. The glass piece 17 is arranged to be slidable with the trim panel structure by using the sliding block structure 19.

In the flat door system provided in this configuration, the body portion 78 is connected with the glass piece 17, so that the body portion 78 and the glass piece 17 move together under the external driving action. The movement of the body portion 78 is limited by the first limiting portion 82 and the second limiting portion 84. The first limiting portion 82 slidably cooperates with the first guiding portion of the trim panel structure. The second limiting portion 84 is slidably cooperates with the second guiding portion of the trim panel structure. The first limiting portion 82 is arranged at a first angle relative to the second limiting portion 84, so that the first limiting portion 82 and the second limiting portion 84 limit the body portion 78 in two intersecting directions, so as to enhance the limiting and guiding for the movement of the glass piece 17 by the sliding block structure 19. Thus, the glass piece 17 and the sliding block structure 19 move in the limit directions determined by the first guiding portion and the second guiding portion, effectively improving the stability of the glass piece 17 in moving. When the external wind resistance acts on the glass piece 17, the glass piece 17 transmits the force to the body portion 78 of the sliding block structure 19. The wind resistance force is shared by the first limiting portion 82 and the second limiting portion 84. The first limiting portion 82 transmits the force to the first guiding portion, and the second limiting portion 84 transmits the force to the second guiding portion. Then the force is transmitted to the trim panel 20 via the first guiding portion and the second guiding portion. The sliding block structure 19 cooperates with the trim panel structure to reduce the wind resistance force, thereby improving the stability of the glass piece 17 in moving.

In the flat door system provided in this configuration, the first limiting portion 82 is arranged at a first angle relative to the second limiting portion 84, so that the first limiting portion 82 and the second limiting portion 84 can limit the body portion 78 in two intersecting directions, so as to enhance the limiting and guiding for the movement of the glass piece 17 by the sliding block structure 19.

In the flat door system provided in this configuration, the first angle between the first limiting portion 82 and the second limiting portion 84 is arranged as 30° to 150°. The angle formed by the first guiding portion and the second guiding portion is arranged to match the first angle. The first limiting portion 82 slidably cooperates with the first guiding portion and the second limiting portion 84 slidably cooperates with the second guiding portion, such that the sliding block structure 19 can slide according to the space provided by the trim panel structure.

As an alternative implementation of this configuration, the first limiting portion 82 is arranged to be perpendicular to the second limiting portion 84. The limiting surface provided by the first limiting portion 82 can be arranged to be parallel to the wall surface of the glass piece 17. The limiting surfaces provided by the two limiting portions 84 can be arranged to be perpendicular to the wall surface of the glass piece 17, so that when the glass piece 17 transmits an external force to the sliding block structure 19, the first limiting portion 82 and the second limiting portion 84 which are perpendicular to each other resists and decomposes the external force, and finally transmit it to the trim panel structure, which is beneficial to improve the stability of the glass piece 17 and reduce the influence of the external force on the movement of the glass piece 17 and the sliding block structure 19 as a unit.

In the flat door system provided in this configuration, at least one first limiting protrusion 88 is provided on the outer wall of the first limiting portion 82. The first limiting protrusion 88 is slidably arranged in the first guiding portion. At least one second limiting protrusion 90 is provided on the outer wall surface of the second limiting portion 84. The second limiting protrusion 90 is slidably arranged in the second guiding portion.

In the flat door system provided in this configuration, the first limiting protrusion 88 is formed on the outer wall surface of the first limiting portion 82. A limiting surface between the first limiting portion 82 and the first guiding portion can be determined by the first limiting protrusion 88. The first limiting protrusion 88 slides relative to the first guiding portion, such that the first limiting portion 82 slides within the first guiding portion, and the first limiting portion 82 and the first guiding portion form a limiting surface for the glass piece 17. The second limiting protrusion 90 is formed on the outer wall surface of the second limiting portion 84. Another limiting surface between the second limiting portion 84 and the second guiding portion can be determined by the second limiting protrusion 90. The second limiting protrusion 90 slides relative to the second guiding portion, such that the second limiting portion 84 slides within the second guiding portion, and the second limiting portion 84 and the second guiding portion form another limiting surface for the glass piece 17. The extension direction of the two limiting surfaces is parallel to the moving direction of the glass piece 17, so as to ensure that the glass piece 17 moves along the extension directions of the first guiding portion and the second guiding portion. The stability of the movement of the glass piece 17 is improved by the first limiting protrusion 88 and the second limiting protrusion 90. The shapes of the two limiting surfaces are specially configured according to the connection between the first limiting protrusion 88 and the first guiding portion, and the connection between the second limiting protrusion 90 and the second guiding portion, respectively.

As an alternative implementation of this configuration, the second limiting protrusions 90 are symmetrically arranged on the second raised portion. The height of the second limiting protrusions 90 in the direction perpendicular to the extending plane of the second raised portion is varied. It is adapted according to the thickness of the seal 76 arranged between the second raised portion and the second guiding portion, so as to sufficiently reduce the sliding clearance, ensure good sealing performance between the sliding block structure 19 and the trim panel 20, and meet the requirements of reasonable sliding resistance.

In the flat door system provided in this configuration, the body portion 78 is provided with at least one recess. The recess is suitable for containing an external adhesive. The space provided by the recess is used for containing the external adhesive. The glass piece 17 is bonded to the sliding block structure 19 by the external adhesive, so that the glass piece 17 and the sliding block structure 19 move together under the driving of external force, ensuring the connection strength between the glass piece 17 and the sliding block structure 19.

In the flat door system provided in this configuration, the body portion 78 is provided with at least one contact foot 86. The contact foot 86 is suitable for connecting to the glass piece 17. A plurality of contact feet 86 and the body portion 78 collectively form the recess. The recess is formed by a plurality of contact feet 86 and the body portion 78 together. The contact feet 86 are arranged to protrude towards the outer side of the body portion 1. After the glass piece 17 is fixed to the sliding block structure 19, the protruding ends of the contact feet 86 abut against the glass piece 17, so that the wind resistance force of the glass piece 17 is transmitted to the body portion 78 via the contacting feet 11, and then transmitted to the first limiting portion 82 and the second limiting portion 84 via the body portion 1.

In the flat door system provided in this configuration, the sliding block structure 19 is a strip-shaped structure. The sliding block structure 19 slides according to the space provided by the trim panel structure. The body portion 1, the first limiting portion 82, and the second limiting portion 84 extend along the sliding direction. A plurality of first limiting protrusions 88 are spaced apart on the first limiting portion 82, and a plurality of first limiting protrusions 88 are spaced apart on the second limiting portion 84, thereby multiple contact limit surfaces are formed between the sliding block structure 19 and the trim panel structure to ensure a reasonable sliding resistance.

In the flat door system provided in this configuration, the sliding block structure 19 is fixedly connected by the glass piece 17, so that the glass piece 17 and the sliding block structure 19 can move together under the driving of external force. By the limiting effect between the first limiting portion 82 and the first guiding portion, and the limiting effect between the second limiting portion 84 and the second guiding portion, the glass piece 17 and the sliding block structure 19 move in the limiting directions determined by the first guiding portion and the second guiding portion, which facilitates to increase the movement accuracy of the glass piece 17 and improve the stability of the movement of the glass piece 17.

As an alternative implementation of this configuration, two or more sliding block structures are provided. The sliding block structures are arranged perpendicularly to and fixedly connected to the side of the glass piece 17. The sliding block structures are driven by the external driving force to displace within the trim panel structure, such that the sliding block structure 19 makes the glass piece 17 to move up and down.

In the flat door system provided in this configuration, the flat door system further includes a seal 76. The seal 76 is integrally provided. The seal 76 is arranged in the first guiding portion and the second guiding portion. The seal 76 abuts against the first limiting portion 82 and the second limiting portion 84. The trim panel structure and the sliding block structure 19 are spaced apart. The seal 76 is arranged between the trim panel structure and the sliding block structure 19. The trim panel structure and the glass piece 17 are spaced apart. The seal 76 is arranged between the trim panel structure and the glass piece 17. The seal 76 is fixedly connected to the trim panel structure. The seal 76 is slidably connected to the glass piece 17.

In the flat door system provided in this configuration, by arranging the seal 76 between the trim panel structure and the glass piece 17, the space gap between the trim panel structure and the glass piece 17 is sealed to prevent external fluids such as airflow and rainwater from entering the flat door system, thereby ensuring the airtightness of the flat door system. By arranging the seal 76 between the trim panel structure and the sliding block structure 19, the gap space between the trim panel structure and the sliding block structure 19 is filled to ensure that the first guiding portion slidably and hermetically abuts against the first limiting portion 82, and the second guiding portion slidably and hermetically abuts against the second limiting portion 84. Thus, the connection strength of the sliding block structure 19, the seal 76, and the trim panel structure is improved. The stability of the glass piece 17 in moving is improved. The seal 76 can absorb and compensate the force on the glass piece 17 under the environment such as wind resistance, which is beneficial to improve the stability of the glass piece 17. The seal 76 is integrally provided to ensure the sealing ability of the whole flat door system, avoid the gap between multiple sealing strips after the installation of these sealing strips and avoid the infiltration of external fluids such as airflow and rainwater.

In the flat door system provided in this configuration, the trim panel structure includes a trim panel 20 having a first connecting plate or exterior member 32, a second connecting plate or branch 38, a third connecting plate or base 42, a fourth connecting plate 43, and a fifth connecting plate or branch 40. The first connecting plate 32 and the third connecting plate 42 are arranged in parallel and spaced apart. The second connecting plate 38, the fourth connecting plate 43, and the fifth connecting plate 40 are arranged in parallel and spaced apart in turn. The second connecting plate 38 is fixedly connected between the first connecting plate 32 and the third connecting plate 42 and is perpendicular to them. The fourth connecting plate 43 and the fifth connecting plate 40 are fixedly connected to the same side of the third connecting plate 42 close to the first connecting plate 32. The first connecting plate 32, the second connecting plate 38, the third connecting plate 42, and the fourth connecting plate 43 form the first guiding portion. The third connecting plate 42, the fourth connecting plate 43, and the fifth connecting plate 40 form the second guiding portion. The first guiding portion limits the sliding movement of the first limiting portion 82, and the second guiding portion limits the sliding movements of the second limiting portion 84, so that the sliding structure slides within the space provided by the trim panel structure.

As an alternative implementation of this configuration, the first connecting plate 32 and the second connecting plate 38 are bonded together. The first connecting plate 32 is the outer trim panel 20 of the door, and the outer trim panel 20 should have good mechanical strength to resist the external impact force.

As an alternative implementation of this configuration, the first connecting plate 32, the second connecting plate 38, the third connecting plate 42, the fourth connecting plate 43, and the fifth connecting plate 40 are made by an integrated molding process. It is beneficial to the easy installation of the whole trim panel structure. The forming strength of each connecting plate is consistent, thus the service life is stable.

In the flat door system provided in this configuration, the outer wall surface of the first connecting plate 32 is coplanar with the outer wall surface of the glass piece 17. The outer wall surface of the glass piece 17 is coplanar with the outer wall surface of the first connecting plate 32. Thus, the connection between the glass piece 17 and the first connecting plate 32 forms a zero-step structure, thereby promoting the smooth transition between the whole glass piece 17 and the first connecting plate 32, reducing the wind resistance coefficient at the connection between the glass piece 17 and the first connecting plate 32, and improving the stability of the glass piece 17.

In the flat door system provided in this configuration, the seal 76 includes a first sealing portion 72, a second sealing portion 100, a third sealing portion 102, and a fourth sealing portion 104 which are connected in sequence. The first sealing portion 72 is arranged between the first connecting plate 32 and the glass piece 17. The first sealing portion 72 is fixedly connected to the first connecting plate 32. The first sealing portion 72 is slidably connected to the glass piece 17. The second sealing portion 100 is fixedly arranged on the inner wall of the first guiding portion. The second sealing portion 100 is adapted to be connected with the first limiting portion 82. The third sealing portion 102 is fixedly arranged on the inner wall of the second guiding portion. The third sealing portion 102 is adapted to be slidably connected with the second limiting portion 84. The fourth scaling portion 104 is slidably arranged on the glass piece 17.

In the flat door system provided in this configuration, the gap space between the first connecting plate 32 and the glass piece 17 is filled and sealed by the first sealing portion 72, so as to prevent external rainwater, airflow and other impurities from entering the flat door system. The second sealing portion 100 slidably abuts against the first limiting portion 82, forming a sealing area between the first guiding portion and the first limiting portion 82. The third sealing portion 102 slidably abuts against the second limiting portion 84, forming a sealing area between the second guiding portion and the second limiting portion 84. The fourth sealing portion 104 slidably abuts against the glass piece 17, so that the glass piece 17 is limited by the fourth sealing portion 104, which is beneficial to improve the stability of the glass piece 17. By the cooperation of the first connecting plate 32, the second connecting plate 38, the third connecting plate 42, the fourth connecting plate 43, and the fifth connecting plate 40, the first sealing portion 72, the second sealing portion 100, and the third sealing portioning 102 collectively limit the movement of the sliding structure and the glass piece 17 as a unit.

As an alternative implementation of this configuration, two or more fourth sealing portions 104 are provided. The fourth sealing portions 104 are arranged obliquely with the glass piece 17. The seal 76 should have good cushioning and shock absorption ability, such that when the glass piece 17 has displaced in the horizontal direction under the external force, the displacement of the glass piece 17 is resisted by the fourth sealing portion 104. The kinetic energy of the glass piece 17 is absorbed by the deformation of the fourth sealing portion 104, which is beneficial to improve the safety of the flat door system.

The flat door system provided in this configuration further includes a mounting structure by which the trim panel structure and the seal 76 are fixedly installed. The mounting structure includes a first mounting plate 112, a second mounting plate 114, and a third mounting plate 116. The first mounting plate 112 is arranged on one side of the first connecting plate 32. The first mounting plate 112 and the second mounting plate 114 are fixedly connected with the first connecting plate 32. The end of the first mounting plate 112 abuts against the end of the second mounting plate 114. The third mounting plate 116 is detachably connected to the second mounting plate 114. The second mounting plate 114 is arranged between the first mounting plate 112 and the third mounting plates 116. The trim panel structure further includes a sixth connecting plate which is detachably connected to the first mounting plate 112. The sixth connecting plate is locked to the first mounting plate 112 by the first locking member 124, so that the trim panel structure is fixedly connected with the mounting structure. Thus, the force transmitted to the trim panel structure is distributed to the mounting structure, thereby improving the ability of the flat door system for overcoming external forces. The second mounting plate 114 is locked to the third mounting plate 116 by the second locking member 126 to improve the connection strength of the whole mounting structure.

In the flat door system provided in this configuration, a bending portion or hook 56 is provided on the end of the first connecting plate 32 away from the glass piece 17. The curved end of the bending portion 56 extends towards the glass piece 17. The bending portion 56 abuts against the second mounting plate 114. The first mounting plate 112 is disposed between the bending portion 56 and the second mounting plate 114. The ends of the first mounting plate 112 and the second mounting plate 114 are fixed together inside the first connecting plate 32 by the bending portion 56, which is beneficial to improve the connection strength between the trim panel structure and the mounting structure.

In the flat door system provided in this configuration, the seal 76 further includes a fifth sealing portion 106. One end of the third mounting plate 116 extends to and is inserted into the fifth sealing portion 106. The fifth sealing portion 106 abuts against the wall surface of the first mounting plate 112. The fifth sealing portion 106 is provided with a plug-in slot. One end of the third mounting plate 116 is arranged in the plug-in slot to form a positioning support for the seal 76, thereby improving the ability of the seal 76 for slidably limiting the glass piece 17.

In the flat door system provided in this configuration, the trim panel structure further includes a connecting bracket 108. The connecting bracket 108 is disposed on the same side of the seal 76 as the second connecting plate 38. The connecting bracket 108 is fixedly connected to the first connecting plate 32. The connecting bracket 108 is fixedly connected to and perpendicular to the second connecting plate 38. The connecting bracket 108 forms an auxiliary support to the first connecting plate 32. The force is transmitted from the first limiting portion 82 of the sliding block structure 19 to the second connecting plate 38, to improve the ability of the first guiding portion for slidably limiting the first limiting portion 82. Meantime, the connection strength between the first connecting plate 32 and the second connecting plate 38 is improved.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

1. A flush glass system for a vehicle door, said flush glass system comprising:
a movable window having a guide structure and an outer surface with said movable window moving between a closed position and an open position during operation;
a trim panel configured to be mounted to the vehicle door, said trim panel including a base portion, an outer portion having an exterior surface disposed on a common plane with said outer surface of said window, and an inner portion spaced from said outer portion with said base, outer, and inner portions defining a first channel extending along a channel axis with said first channel receiving said guide structure of said movable window;
a seal at least partially mounted within said first channel with said guide structure slidably coupled to said seal and moveable within said seal during operation of said movable window, said seal including an exterior sealing lip at least partially disposed between said movable window and said trim panel with said exterior sealing lip having an exposed surface forming a flush connection between said outer surface of said movable window and said exterior surface of said outer portion of said trim panel while maintaining a continuous engagement between said trim panel and said movable window; and
a below belt member formed separately from said trim panel and configured to be separately mounted to the vehicle door below said trim panel, said below belt member defining a second channel extending along said channel axis to receive said guide structure of said movable window and to guide movement of said movable window, with said second channel aligned with said first channel of said trim panel to allow continuous movement of said movable window as said movable window moves between said closed and open positions;
wherein during installation, said guide structure of said movable window is disposed within said second channel of said below belt member prior to being disposed in said first channel of said trim panel to ease installation of said flush glass system in assembling said trim panel, said movable window, and said below belt member.

2. The flush glass system of claim 1, wherein said trim panel has an upper end and a lower end with at least said outer portion and inner portion extending from said upper end to a flared portion at said lower end of said trim panel.

3. The flush glass system of claim 2, wherein said below belt member includes a flared portion with said flared portion of said below belt member extending towards said flared portion of said trim panel to aid in the alignment of said first channel and said second channel along said channel axis.

4. The flush glass system of claim 2, wherein said outer and inner portions extend substantially parallel to each other at said upper end and transitions outwards from each other at said lower end of said trim panel to form said flared portion.

5. The flush glass system of claim 2, wherein said first channel widens as said outer and inner portions transitions outwards to form said flared portion.

6. The flush glass system of claim 1, wherein said trim panel is spaced from and adjacent to said below belt member once installed.

7. The flush glass system of claim 1, wherein said inner portion of said trim panel is further defined as an inner branch with said inner branch having a plurality of spaced projections defining alternating slots.

8. The flush glass system of claim 1, wherein said below belt member includes an inner branch having a plurality of spaced projections defining alternating slots.

9. The flush glass system of claim 1, wherein said outer portion of said trim panel further includes an outer branch having a mounting feature for facilitating mounting of said trim panel to said vehicle door and wherein said mounting feature defines alternating passageways along said outer branch.

10. (canceled)

11. The flush glass system of claim 1, wherein said below belt member includes a base portion, an outer portion, and an inner portion extending from an upper end to a lower end with said outer portion and inner portion extending from said lower end to a flared portion at said upper end of said below belt member, and
wherein said outer and inner portions of said below belt member extend substantially parallel to each other at said lower end and transitions outwards from each other at said upper end of said below belt member to form said flared portion.

12. (canceled)

13. The flush glass system of claim 1, wherein said movable window includes a glass pane having an outer surface, an inner surface, and edges bounding the glass pane, and said guide structure is mounted to said glass pane, and
wherein said guide structure includes a body portion, a connecting portion, a first limiting portion, and a second limiting portion with said first limiting portion, second limiting portion, and connecting portion extending from said body portion.

14. (canceled)

15. The flush glass system of claim 13, wherein said connecting portion of said guide structure is coupled to said inner surface of said glass pane to support said glass pane as said movable window moves between said closed and open positions.

16-17. (canceled)

18. A flush glass system for a vehicle door having a movable window with the movable window having a guide portion, said flush glass system comprising:
a trim panel configured to be mounted to the vehicle door, said trim panel defining a first channel extending along a channel axis for receiving the guide structure of the movable window;
a seal at least partially mounted within said first channel for receiving the guide structure where the guide structure is moveable within said seal during operation of the movable window, said seal including an exterior sealing lip; and
a below belt member formed separately from said trim panel and configured to be separately mounted to the vehicle door below and spaced from said trim panel, said below belt member defining a second channel extending along said channel axis for receiving the guide structure of the movable window to guide movement of the movable window, with said second channel being aligned with said first channel of said trim panel for allowing continuous movement of the movable window between said first channel of said trim panel and said second channel of said below belt member as the movable window moves between closed and open positions;
wherein said below belt member is configured to receive the guide structure of the movable window within said second channel prior to said trim panel receiving the guide structure of the movable window within said first channel for easing installation of said flush glass system in assembling said trim panel, the movable window, and said below belt member.

19. The flush glass system of claim 18, wherein said trim panel has an upper end and a lower end with at least said outer and inner portions extending substantially parallel to each other at said upper end and transitioning outwards from each other at said lower end to form a flared portion.

20. The flush glass system of claim 19, wherein said first channel widens as said outer and inner portions transitions outwards from each other to form said flared portion.

21. The flush glass system of claim 19, wherein said below belt member includes a flared portion with said flared portion of said below belt member extending towards said flared portion of said trim panel to aid in the alignment of said first channel and said second channel along said channel axis.

22. The flush glass system of claim 21, wherein said flared portion of said trim panel is spaced from said flared portion of said below belt member.

23. The flush glass system of claim 18, wherein said trim panel is spaced from and adjacent to said below belt member once installed.

24. The flush glass system of claim 18, further including a second seal at least partially mounted within said second channel of said below belt member.

25. The flush glass system of claim 18, wherein said seal includes at least one wear strip extending along the length of said seal.

26. A method of installing a flush glass system onto a vehicle door with the flush glass system having a movable window, a trim panel defining a first channel extending along a channel axis, and a below belt member defining a second channel extending along the channel axis, said method comprising the steps of:
mounting the below belt member to the vehicle door;
sliding the guide structure of the movable window downwards along the second channel of the below belt member;
positioning the trim panel adjacent to the below belt member after the movable window is disposed within the second channel of the below belt member and simultaneously sliding the guide structure of the movable window along the first channel such that the first channel of the trim panel is aligned with the second channel of the below belt member; and
mounting the trim panel to the vehicle door.

27. The method as set forth in claim 26, wherein the trim panel has a flared portion, wherein the step of positioning the trim panel is further defined as positioning the flared portion towards and adjacent the below belt member to aid in the alignment of the first channel and the second channel along the channel axis.

28. The method as set forth in claim 27, wherein the below belt member has a flared portion, wherein the step of positioning the trim panel is further defined as positioning the flared portion of the trim panel towards and spaced from the flared portion of the below belt member to aid in the alignment of the first channel and the second channel along the channel axis.

29. The method as set forth in claim 26, wherein the flush glass system further includes a seal, and further including the step of mounting the seal within the first channel of the trim panel prior to positioning and mounting the trim panel.

30. The method as set forth in claim 29, wherein the flush glass system further includes a second seal, and further including the step of mounting the second seal within the second channel of the below belt member prior to mounting the below belt member.

31-75. (canceled)
